(19) United States
(12) Patent Application Publication
(10) Pub. No.: US 2026/0050193 A1
(43) Pub. Date: Feb. 19, 2026

(54) PIXEL CIRCUIT SUBSTRATE, SPATIAL LIGHT MODULATOR, AND DISPLAY SYSTEM

(71) Applicant: LG Display Co., Ltd., Seoul (KR)

(72) Inventor: Kazuki WATANABE, Kanagawa (JP)

(21) Appl. No.: 18/957,117

(22) Filed: Nov. 22, 2024

(30) Foreign Application Priority Data
Dec. 28, 2023 (JP) 2023-222518

(51) Int. Cl. G02F 1/1368; G02F 1/1362

(52) U.S. Cl. CPC G02F 1/1368; G02F 1/136286

(57) ABSTRACT

A pixel circuit substrate includes: a plurality of pixel electrodes; a plurality of active layer regions extending across adjacent pixel electrodes and arranged in a direction intersecting an arrangement direction of the plurality of pixel electrodes; a plurality of driving switches respectively formed at the plurality of active layer regions; a plurality of control lines each of which is connected between each control terminal and a corresponding one of the plurality of pixel electrodes; a scan line arranged between the plurality of driving switches and the plurality of pixel electrodes and connected to a scan terminal; and a data line arranged between the plurality of driving switches and the plurality of pixel electrodes and connected to a data terminal, wherein the scan line bypasses the plurality of control lines and extends between the plurality of driving switches and the plurality of pixel electrodes.

### CROSS-REFERENCE TO RELATED APPLICATIONS

The present application claims the priority benefit of Japanese Patent Application No. 2023-222518 filed in Japan on Dec. 28, 2023, which is hereby incorporated by reference in its entirety for all purposes as if fully set forth herein.

### BACKGROUND

### Technical Field

The present disclosure relates to a pixel circuit substrate for a spatial light modulator, a spatial light modulator including the pixel circuit, and a display system including the spatial light modulator.

### Description of the Related Art

In recent years, a pixel electrode having a fine pixel surface has been demanded for realizing a high-precision display. It is known that as the pixel surface of the pixel electrode is made fine, a channel length of a driving switch of the pixel circuit is shortened, resulting in a decrease in voltage withstand capability. Patent Document 1 discloses a circuit configuration in which two pixel circuits having an aspect ratio of 4:1 are each spread over two pixel electrodes.

### PRIOR ART DOCUMENT

Patent Document 1: U.S. Patent Application Publication No. 2007/0247695.

### BRIEF SUMMARY

In the circuit configuration of Patent Document 1, it is possible to secure the voltage withstand capability of the driving switch even if the pixel surface of the pixel electrode is made fine. However, since a width of the pixel circuit in a short-axis direction is shorter than a width of the pixel electrode in the short-axis direction, there is a problem that it is difficult to wire a scan line or data line connected to the driving switch.

An advantage of the present disclosure is to provide a pixel circuit substrate, a spatial light modulator, and a display system that can secure a voltage withstand capability of a driving switch while enabling arrangement of a scan line or data line connected to the driving switch.

Additional features and advantages of the disclosure will be set forth in the description which follows, and in part will be apparent from the description, or may be learned by practice of the disclosure. These and other advantages of the disclosure will be realized and attained by the structure particularly pointed out in the written description and claims hereof as well as the appended drawings.

To achieve these and other advantages and in accordance with the purpose of the present disclosure, as embodied and broadly described herein, a pixel circuit substrate for a spatial light modulator includes: a plurality of pixel electrodes arranged at intervals from each other and each including a pixel surface defining a pixel of the spatial light modulator; a plurality of active layer regions extending across adjacent pixel electrodes at positions overlapping the pixel surfaces of the adjacent pixel electrodes and arranged at intervals from each other in a direction intersecting an arrangement direction of the plurality of pixel electrodes; a plurality of driving switches respectively formed at the plurality of active layer regions and each including a scan terminal, a data terminal, and a control terminal; a plurality of control lines each of which is connected between each control terminal and a corresponding one of the plurality of pixel electrodes; a scan line arranged between the plurality of driving switches and the plurality of pixel electrodes and connected to the scan terminal of each of the plurality of active layer regions; and a data line arranged between the plurality of driving switches and the plurality of pixel electrodes and connected to the data terminal of each of the plurality of driving switches, wherein the scan line bypasses the plurality of control lines and extends between the plurality of driving switches and the plurality of pixel electrodes.

In another aspect, a spatial light modulator includes: the pixel circuit substrate; a transparent electrode forming a driving circuit together with a pixel circuit of the pixel circuit substrate; and a light modulation layer disposed between the plurality of pixel electrodes and the transparent electrode and to which voltage is applied from the driving circuit.

In another aspect, a display system includes the spatial light modulator.

It is to be understood that both the foregoing general description and the following detailed description are exemplary and explanatory and are intended to provide further explanation of the disclosure as claimed.

### BRIEF DESCRIPTION OF THE SEVERAL VIEWS OF THE DRAWINGS

The accompanying drawings, which are included to provide a further understanding of the disclosure and are incorporated in and constitute a part of this specification, illustrate embodiments of the disclosure and together with the description serve to explain the principles of the disclosure. In the drawings:

FIG. 1 is a block diagram illustrating an example of a configuration of a display system according to an embodiment;

FIG. 2A is a block diagram illustrating an example of an arrangement of a spatial light modulator in the configuration of the display system of FIG. 1;

FIG. 2B is a block diagram illustrating another example of an arrangement of a spatial light modulator in the configuration of the display system of FIG. 1;

FIG. 3 is a view schematically illustrating an example of a structure of a spatial light modulator according to an embodiment;

FIG. 4A is a perspective view schematically illustrating an example of a partial structure of a pixel circuit substrate according to an embodiment;

FIG. 4B is a perspective view schematically illustrating an example of an additional partial structure of a pixel circuit substrate to an embodiment, added to FIG. 4A;

FIG. 4C is a perspective view schematically illustrating an example of an additional partial structure of a pixel circuit substrate according to an embodiment, added to FIG. 4B;

FIG. 4D is a perspective view schematically illustrating an example of an additional partial structure of a pixel circuit substrate according to an embodiment, added to FIG. 4C;

FIG. 4E is a perspective view schematically illustrating an example of an additional partial structure of a pixel circuit substrate according to an embodiment, added to FIG. 4D;

FIG. 4F is a perspective view schematically illustrating an example of an additional partial structure of a pixel circuit substrate according to an embodiment, added to FIG. 4E;

FIG. 4G is a perspective view schematically illustrating an example of an additional partial structure of a pixel circuit substrate according to an embodiment, added to FIG. 4F;

FIG. 4H is a perspective view schematically illustrating an example of an additional partial structure of a pixel circuit substrate according to an embodiment, added to FIG. 4G;

FIG. 4I is a perspective view schematically illustrating an example of an overall structure of a pixel circuit substrate according to an embodiment, with an example of an additional partial structure of a pixel circuit substrate according to an embodiment added to FIG. 4H;

FIG. 5 is a schematic plan view of a pixel surface of a pixel electrode in the pixel circuit substrate of FIG. 4I, viewed along a negative direction of a Z axis;

FIG. 6A is a perspective view schematically illustrating an example of entire wirings in the pixel circuit substrate of FIG. 4I;

FIG. 6B is a perspective view schematically illustrating an example of wirings of a n-th driving switch in the pixel circuit substrate of FIG. 4I;

FIG. 6C is a perspective view schematically illustrating an example of wirings of a n+1-th driving switch in the pixel circuit substrate of FIG. 4I;

FIG. 6D is a perspective view schematically illustrating an example of wirings of a n+2-th driving switch in the pixel circuit substrate of FIG. 4I;

FIG. 6E is a perspective view schematically illustrating an example of wirings of a n+3-th driving switch in the pixel circuit substrate of FIG. 4I;

FIG. 7A is an example of a cross-sectional view along a line A-A of FIG. 5, corresponding to FIG. 6E;

FIG. 7B is a modified example of a cross-sectional view along a line A-A of FIG. 5;

FIG. 8A is a schematic view illustrating an example of data lines and scan lines in a part of a pixel circuit of a spatial light modulator according to an embodiment;

FIG. 8B is a schematic view illustrating an example of entire wirings in a part of a pixel circuit of a spatial light modulator according to an embodiment;

FIG. 8C is a circuit diagram illustrating an example of a part of a driving circuit of a spatial light modulator according to an embodiment;

FIG. 9A is a schematic view illustrating a modified example of FIG. 8A;

FIG. 9B is a schematic view illustrating a modified example of FIG. 8B;

FIG. 9C is a circuit diagram illustrating a modified example of FIG. 8C;

FIG. 10 is a circuit diagram illustrating another modified example of FIG. 8C; and

FIG. 11 is a circuit diagram illustrating a modified example of a circuit configuration in a dotted line region B of FIG. 8C.

### DETAILED DESCRIPTION

Hereinafter, embodiments of the present disclosure are described in detail with reference to the drawings. Embodiments described below are examples and are not to be construed as being limited by this description.

Hereinafter, embodiments according to the present disclosure are described with reference to the accompanying drawings. In the accompanying drawings, identical elements or parts, elements or parts having the same function are given the same reference numerals or reference numerals thereof are omitted. In addition, the following embodiments are exemplary, and the contents of the present disclosure should not be limited by the description of the embodiments.

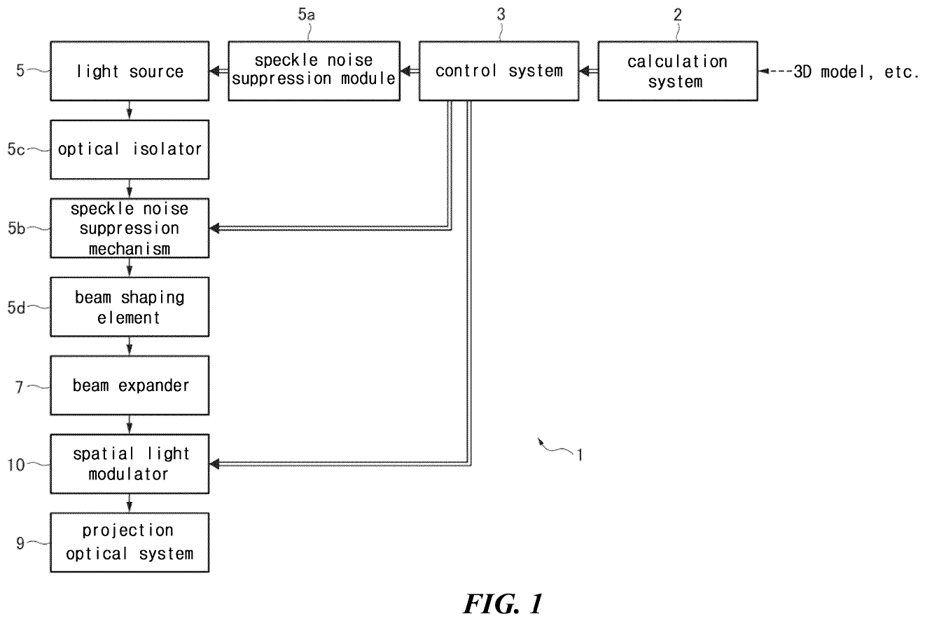

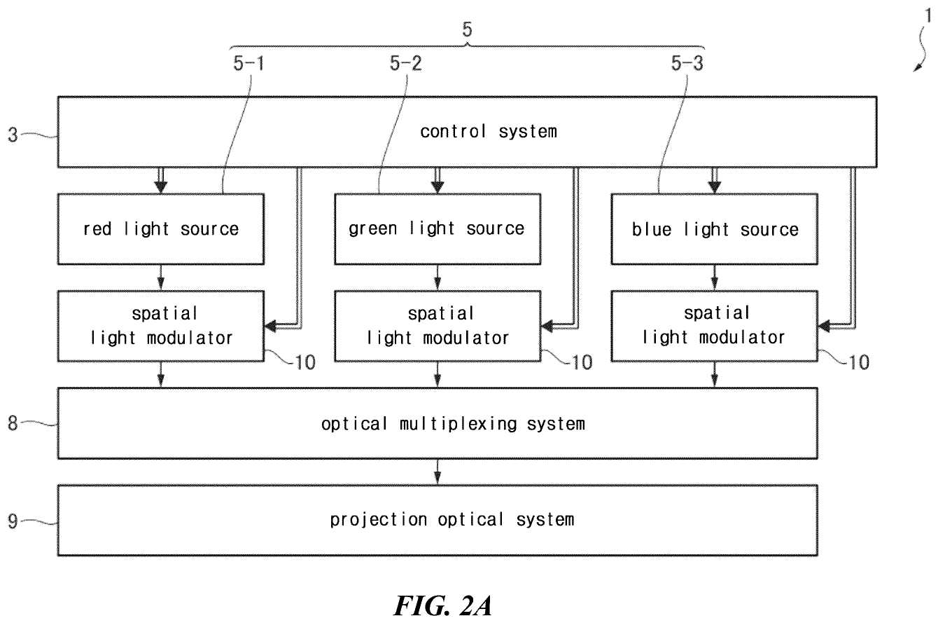

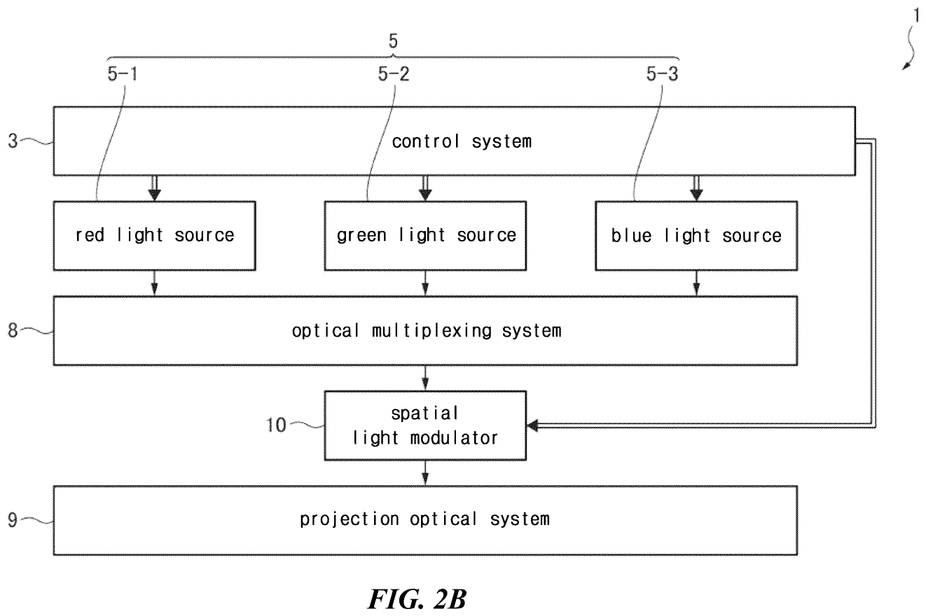

First, with reference to FIGS. 1, 2A and 2B, a display system 1 according to an embodiment is described. In FIGS. 1, 2A and 2B, a flow of light signal is depicted by a solid arrow, a flow of data is depicted by a dashed line, and a flow of electric signal is depicted by a double arrow.

The display system 1 is configured as a high-precision display. In FIG. 1, an example of a configuration of a holographic display for hologram reproduction that is as an example of a high-precision display is illustrated.

The display system 1 is equipped with a calculation system 2. The calculation system 2 acquires an image to be reproduced as a hologram as a three-dimensional (3D) model, etc., and calculates a hologram by a hologram generation algorithm. The calculation system 2 is configured as a computer device or microcomputer.

A method by which the calculation system 2 acquires an image to be reproduced as a hologram is not particularly limited. For example, the image to be reproduced as a hologram by the calculation system 2 can be acquired by connecting by wire or wirelessly with an external device capable of reproducing an image, such as an imaging device, for example, a camera, or an image device, for example, a television receiver. In addition, the image to be reproduced as a hologram by the calculation system 2 can be acquired by reading a removable medium such as a USB memory that stores the image.

In addition, the hologram generation algorithm can be selected from any algorithm depending on purpose or use of hologram reproduction and is not limited, but can be, for example, a Wavefront Recording Method or Random Phase-Free Method.

The display system 1 is equipped with a control system 3. The control system 3 receives the hologram calculated in the operation system 2 as an image signal, and outputs a control signal based on the image signal.

The control system 3 is configured as a computer device or microcomputer, a dedicated hardware, or a combination thereof. When the control system 3 is configured as a computer device or microcomputer, the control system 3 can be configured in the same computer device or microcomputer as the calculation system 2, or can be configured in a separate computer device or microcomputer from the calculation system 2.

When the control system 3 is a computer device or microcomputer, the control system 3 includes a CPU (Central Processing Unit) or an MPU (Micro Processing Unit). When the control system 3 includes the CPU or MPU, each function executed by the control system 3 is realized by software, firmware, or a combination of software and firmware. The software or firmware is described as a program by a programming language. The program is stored in an internal memory of the control system 3, and the program stored in the internal memory is read and executed by the CPU or MPU. Each function in the control system 3 is realized by the CPU or MPU reading and executing the program stored in the internal memory. The internal memory is, for example, a nonvolatile or volatile semiconductor memory, such as RAM, ROM, flash memory, EPROM, or EEPROM.

If the control system 3 is a dedicated hardware, control processing in the control system 3 is realized by, for example, a single circuit, a composite circuit, an ASIC (application specific integrated circuit), an FPGA (field-programmable gate array), or a circuit combining these. Each function to be realized by the control system 3 can be realized by individual hardware, or all functions can be realized by a single hardware.

In addition, when the operation system 2 or the control system 3 is a computer device, a type of the computer device is not particularly limited. The computer device can be, for example, a virtual server providing a cloud service, or a physical server providing various services to a group within a local network. In addition, the computer device can be a quantum computer, a general-purpose desktop or laptop computer, or a portable terminal such as a tablet terminal or a smart phone. In addition, the operation system 2 or the control system 3 can be designed to perform distributed processing using a plurality of computer devices.

The display system 1 includes a light source 5, a beam expander 7, a projection optical system 9, and a spatial light modulator 10. Operations of the light source 5 and the spatial light modulator 10 are controlled by control signals received from the control system 3.

The light source 5 irradiates a beam of light toward the spatial light modulator 10 based on the control signal received from the control system 3. As the light source 5, a coherent light source having a coherence length according to purpose or use of hologram reproduction is used. Although not limited to the coherent light source, a solid-state light source including a light emitting diode is used, and for example, a laser light source including a laser diode or an SLD (Super Luminescent Diode) light source including a super luminescent diode is preferable.

The beam expander 7 expands a beam of light irradiated from the light source 5 and guides it to an entire light modulation region of the spatial light modulator 10. The beam expander 7 is arranged on a light propagation path between the light source 5 and the spatial light modulator 10. The beam expander 7 is selected from any optical element depending on purpose or use of hologram reproduction. For example, the beam expander 7 can be, but not limited to, a Galilean transmission-type beam expander including a concave lens and a convex lens, a Keplerian transmission-type beam expander including two convex lenses, or a reflective expander including a curved mirror. In addition, the concave lens and the convex lens in the transmission-type beam expander can be diffractive optical elements having the same refractive characteristics. In addition, the curved mirror in the reflective expander can be a diffractive optical element having the same reflective characteristics.

The spatial light modulator 10 is an optical device that modulates spatial distribution of light from the light source 5, such as amplitude, phase, or propagation direction. The spatial light modulator 10 has a light modulation region formed therein. The optical characteristics such as reflection or refraction in the light modulation region of the spatial light modulator 10 are electrically controlled by the control signal from the control system 3. By the control signal from the control system 3, a parameter such as the amplitude, phase, or propagation direction of the beam of the light that is irradiated from the light source 5 and expanded in the beam expander 7 is modulated in the light modulation region of the spatial light modulator 10. The detailed configuration of the spatial light modulator 10 is described later.

The projection optical system 9 processes the light beam modulated in the spatial light modulator 10 at a position to be viewed by a user, and reproduces a stereoscopic image such as a three-dimensional hologram. The projection optical system 9 can be formed by, but not limited to, combining a lens, a mirror, and a diffractive optical element having optical characteristics equivalent to those of lens and mirror.

Although not shown, in a case where the spatial light modulator 10 modulates the amplitude of the incident light, the display system 1 is provided with a polarization separation element, which separates the light beam into two light beams, in the light propagation path between the spatial light modulator 10 and a viewer such as a stereoscopic image viewer. The polarization separation element is an optical element that adjusts a ratio of vertical and horizontal polarization by separating polarization planes. Here, it has a function of controlling an intensity of light according to the polarization state of an input light. The polarization separation element can use, for example, but not limited to, a polarizing plate or a polarizing beam splitter (PBS). The polarization separation element can be further arranged in the light propagation path between the light source 5 and the spatial light modulator 10 depending on polarization characteristics of the light source 5. In addition, in a case where the spatial light modulator 10 does not modulate the amplitude of the incident light, the polarization separation element can be omitted.

In addition, in a case where the light source 5 is a coherent light source, it is preferable that the display system 1 is equipped with a speckle noise suppression module 5a. Speckle noise can occur in light with high coherence, such as a light beam irradiated from a coherent light source, and is noise that occurs when multiple waves overlap and interfere with each other in a complex manner.

The speckle noise suppression module 5a can be formed as, but not limited to, a high-frequency superposition circuit that performs frequency modulation on a power of the light source 5, for example, a driving current. The speckle noise suppression module 5a is electrically controlled by a control signal from the control system 3. The speckle noise suppression module 5a can desirably reduce the coherence of the light beam irradiated from the light source 5 by performing frequency modulation on the power of the light source 5, thereby reducing the speckle noise.

In addition, the speckle noise suppression module 5a can be formed separately from the light source 5 or can be built into the light source 5.

In addition, in the case where the light source 5 is a coherent light source, it is preferable that the display system 1 be equipped with a speckle noise suppression mechanism 5b on a light output side of the light source 5. The speckle noise suppression mechanism 5b is formed with, for example, but not limited to, a rotatable diffuser plate, so that the rotation of the diffuser plate is electrically controlled by a control signal from the control system 3. The speckle noise suppression mechanism 5b can desirably reduce the coherence of the light beam irradiated from the light source 5 by the rotation of the diffuser plate, thereby reducing the speckle noise.

In addition, the speckle noise suppression mechanism 5b can be formed separately from the light source 5 or can be built into the light source 5.

In addition, the speckle noise suppression module 5a and the speckle noise suppression mechanism 5b can be omitted in a case where a coherent light source is not used or where speckle noise does not need to be considered, but not limited thereto.

In addition, it is preferable that the display system 1 has an optical isolator 5c on the output side of the light source 5. The optical isolator 5c suppresses a beam of light irradiated from the light source 5 from returning to the light source 5 by reflection. By forming the optical isolator 5c on the output side of the light source 5, fluctuations in the output of the light source 5 can be suppressed, so that stability of the light source 5 or the entire display system 1 can be improved. In addition, by forming the optical isolator 5c on the output side of the light source 5, optical damage to the light source 5 can be prevented.

In addition, the optical isolator 5c can be formed separately from the light source 5 or can be built into the light source 5. In addition, in a case of forming the optical isolator 5c on the output side of the light source 5, it is preferable not to place an optical component between the light source 5 and the optical isolator 5c in order to prevent reflection between the light source 5 and the optical isolator 5c. In addition, the optical isolator 5c can be omitted in a case where there is no need to consider beam reflection of light irradiated from the light source 5, but not limited thereto.

In addition, the display system 1 is preferably equipped with a beam shaping element 5d on the output side of the light source 5 according to quality of the light beam irradiated from the light source 5, for example, parallelism or uniformity of intensity in a plane. The beam shaping element 5d can be, for example, but not limited to, a spatial filter including a lens and a pinball. By forming the beam shaping element 5d on the output side of the light source 5, a light beam whose parallelism is reduced due to interference with an optical component can be shaped, so that a light beam with a high parallelism can be incident on the spatial light modulator 10.

Therefore, the beam shaping element 5d is preferably arranged on an upstream side of the beam expander 7 in the light propagation path between the light source 5 and the spatial light modulator 10. In addition, it is preferable not to arrange an optical component between the beam expander 7 and the beam shaping element 5d. By the arrangement described above, it becomes possible to expand the light beam with high parallelism formed by the beam shaping element 5d by the beam expander 7, and to cause the expanded light beam with high parallelism to be incident on the light modulation region of the spatial light modulator 10.

In addition, the beam shaping element 5d can be replaced with an optical device having the same function as the spatial light modulator 10. In this case, the optical device having the same function as the spatial light modulator 10 can electrically control quality of the light beam by a control signal from the control system 3.

In addition, although not limited, in a case there is no deterioration in quality of the light beam irradiated from the light source 5, for example, no deterioration in parallelism, the beam shaping element 5d can be omitted.

In FIGS. 2A and 2B, examples of arrangement of the spatial light modulator 10 for realizing full-color hologram reproduction in the display system 1 are illustrated. In addition, the examples of the arrangement of FIGS. 2A and 2B is merely examples, and the arrangement of the spatial light modulator 10 is not limited to either of FIGS. 2A and 2B. The arrangement of the spatial light modulator 10 for realizing full-color hologram reproduction can be arbitrarily selected according to purpose or use of the hologram reproduction.

The display system 1 in each of FIGS. 2A and 2B is equipped with an optical multiplexing system 8. The optical multiplexing system 8 combines multiple light beams having different wavelengths into a single light beam. The optical multiplexing system 8 is formed as, for example, but not limited to, a filter type, prism type, grating type, or waveguide type optical multiplexer. It is preferable that the optical multiplexing system 8 be formed as a waveguide type optical multiplexer.

FIG. 2A is an example in which a spatial light modulator 10 is arranged for each of a red light source 5-1, a green light source 5-2, and a blue light source 5-3 arranged as light sources 5 of the display system 1. In the arrangement example of FIG. 2A, a red light beam, a green light beam, and a blue light beam modulated by the respective spatial light modulators 10 are combined by the optical combining system 8 and then transmitted to the projection optical system 9 as a single light beam.

Meanwhile, FIG. 2B is an example in which a single spatial light modulator 10 is arranged for a red light source 5-1, a green light source 5-2, and a blue light source 5-3. In the arrangement example of FIG. 2B, a red light beam, a green light beam, and a blue light beam respectively irradiated from the red light source 5-1, the green light source 5-2, and the blue light source 5-3 are combined by the optical multiplexing system 8, and the combined single light beam is incident on the spatial light modulator 10. Thereafter, the single light beam modulated by the spatial light modulator 10 is transmitted to the projection optical system 9.

In the arrangement example of FIG. 2A, since the red light beam, the green light beam, and the blue light beam can be modulated simultaneously by the individual spatial light modulators 10, an image can be updated at a high frequency. Therefore, in the arrangement example of FIG. 2A, video characteristics in hologram reproduction can be improved.

Meanwhile, in the arrangement example of FIG. 2A, since the spatial light modulator 10 is arranged for each of the red light source 5-1, the green light source 5-2, and the blue light source 5-3, a number of optical components of the display system 1 increases compared to the arrangement example of FIG. 2B. In addition, since the modulated light beams are transmitted from the respective spatial light modulators 10 to the optical multiplexing system 8, there are cases where it becomes difficult to adjust positions of the spatial light modulators 10. Therefore, in the arrangement example of FIG. 2A, the configuration of the display system 1 can become complicated.

In the arrangement example of FIG. 2B, since the combined single light beam is modulated by the single spatial light modulator 10, the configuration of the display system 1 can be simplified.

Meanwhile, in the arrangement example of FIG. 2B, since turning on and turning off each of the red light source 5-1, the green light source 5-2, and the blue light source 5-3 are performed sequentially, full-color hologram reproduction is realized. Therefore, in order to improve video characteristics in hologram reproduction, it is necessary to drive the light source 5 of each color at a high frequency, so power consumption of the display system 1 is likely to increase compared to the arrangement example of FIG. 2A.

In addition, when realizing full-color hologram reproduction in the display system 1, the light source 5 and the spatial light modulator 10 need to be synchronized with each other because the hologram changes depending on wavelength of light. The synchronization of the light source 5 and the spatial light modulator 10 can be performed by the control system 3, or can be performed by a control mechanism such as a separate electronic circuit for the purpose of the synchronization.

In addition, when realizing hologram reproduction in the display system 1, a gradation of a light intensity on a reproduced stereoscopic image can be adjusted by a hologram, or can be achieved by a combination of intensity modulation of the light source 5 and adjustment by a hologram. In addition, as a method for adjusting the gradation of the light intensity in the reproduction of the stereoscopic image, a time-division gradation display method is known in which a plurality of turn-on times is set within one frame, and desired turn-on times among the plurality of turn-on times are combined to conduct turn-ons, thereby expressing a predetermined luminance gradation. When realizing full-color hologram reproduction, the gradation of the light intensity on the reproduced stereoscopic image can be achieved by a combination of the above time-division gradation display method and the adjustment by the hologram.

In addition, when realizing hologram reproduction in the display system 1, a number of the light sources 5 in the display system 1 can be any quantity depending on the purpose or use of the hologram reproduction.

The display system 1 that realizes hologram reproduction has been described above, but the display system 1 can be for purposes other than hologram reproduction. For example, by lowering coherence of light beam in the entire display system 1 compared to the display system 1 for hologram reproduction, the display system 1 can be a high-precision display system that projects display content of the spatial light modulator 10 onto the projection optical system 9.

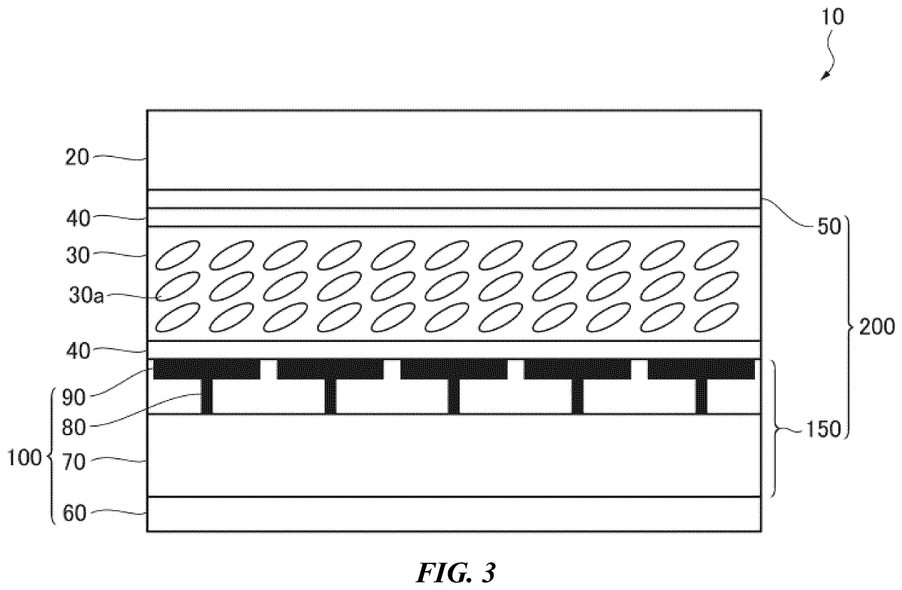

Hereinafter, the spatial light modulator 10 according to an embodiment is described with reference to FIG. 3.

The spatial light modulator 10 includes a cover glass 20. The cover glass 20 forms an aesthetic surface (or outer surface) of the spatial light modulator 10 and defines a light input surface of the light modulation region of the spatial light modulator 10. A material of the cover glass 20 is preferably for use in display. For example, the material of the cover glass 20 can be, but not limited to, sapphire glass, quartz glass, or alkali-free glass.

In addition, an anti-reflection film can be formed on the aesthetic surface (or outer surface) of the cover glass 20 depending on purpose or use of the spatial light modulator 10. By forming the anti-reflection film on the cover glass 20, reflection of light incident on the surface of the cover glass 20 is suppressed, so that modulation efficiency in the spatial light modulator 10 can be improved.

In addition, a material of the anti-reflection film can use, for example, SiO2, MgF2, TiO2, Ta2O5, ZrO2, or Nb2O5, but not limited thereto. In addition, the antireflection film can be formed in multiple layers on the aesthetic surface of the cover glass 20 by coating an organic resist using an organic acid such as alkyl sulfonic acid to the aesthetic surface of the cover glass 20 and then depositing magnesium fluoride, etc.

The spatial light modulator 10 includes a light modulation layer 30. The light modulation layer 30 is formed of, for example, a liquid crystal which is a conductive material having both of the same fluidity as a liquid and the same anisotropy as a liquid crystal. By forming the light modulation layer 30 of a liquid crystal, anisotropy of liquid crystal molecules 30a can be changed according to a magnitude of an applied voltage, so that it becomes possible to modulate optical characteristics such as reflection or refraction in the light modulation layer 30.

The light modulation layer 30 can use any liquid crystal material depending on purpose or use of the spatial light modulator 10. The light modulation layer 30 uses, for example, but not limited to, a ferroelectric liquid crystal or a nematic liquid crystal. It is preferable to use a ferroelectric liquid crystal as the light modulation layer 30. The ferroelectric liquid crystal has liquid crystal molecules 30a that have spontaneous polarization, and can prevent interference between adjacent pixels of the spatial light modulator 10 due to an electric field compared to the nematic liquid crystal.

The spatial light modulator 10 includes an alignment layers 40. The alignment layers 40 are arranged in contact with both side surfaces of the light modulation layer 30, that is, a surface of the light modulation layer 30 on a side of the cover glass 20 and an opposite surface, respectively. The alignment layers 40 are formed of an insulator. The alignment layers 40 are formed of, for example, but not limited to, an organic material such as polyimide or an inorganic material such as SiO2 (silica).

The surfaces of the alignment layers 40 can be adjusted to adjust alignment state of the liquid crystal molecules 30a in the light modulation layer 30 by manipulation such as rubbing. In addition, an alignment direction of the liquid crystal molecules 30a provided by the alignment layer 40 arranged on one side of the light modulation layer 30 can be parallel to an alignment direction of the liquid crystal molecules 30a provided by the alignment layer 40 arranged on the opposite side, or can be in a twisted position with an alignment direction of the liquid crystal molecules 30a provided by the alignment layer 40 arranged on the opposite side.

The spatial light modulator 10 includes a transparent electrode 50 and a pixel circuit substrate 100.

The transparent electrode 50 is arranged between the cover glass 20 and the alignment layer 40 that is arranged on the cover glass side of the light modulation layer 30. The transparent electrode 50 forms a driving circuit 200 in the spatial light modulator 10 together with a pixel circuit 150 of the pixel circuit substrate 100.

The transparent electrode 50 is formed as a conductive film capable of transmitting light. The transparent electrode 50 is formed by, for example, but not limited to, indium tin oxide (ITO) such as index-matching ITO (IMITO), tin oxide, magnesium-silver alloy, or polythiophene-based conductive polymer using PEDOT (polyethylene dioxythiophene).

The pixel circuit substrate 100 includes a substrate 60 and a pixel circuit 150 formed on the substrate 60. The pixel circuit 150 includes a driving switch circuit 70, a plurality of pixel electrodes 90, and a plurality of control lines 80 connecting the plurality of driving switch circuit 70 and the plurality of pixel electrodes 90, respectively.

The pixel circuit substrate 100 is arranged such that the plurality of pixel electrodes 90 face the transparent electrode 50 with the light modulation layer 30 and the alignment layers 40 disposed on both sides of the light modulation layer 30 interposed between the plurality of pixel electrodes 90 and the transparent electrode 50. That is, in the spatial light modulator 10, the light modulation layer 30 is disposed between the plurality of pixel electrodes 90 and the transparent electrode 50.

In the spatial light modulator 10, since the light modulation layer 30 is disposed between the plurality of pixel electrodes 90 and the transparent electrode 50, a voltage is applied to the light modulation layer 30 from the driving circuit 200, and the optical characteristics of the light modulation layer 30 can be modulated by electrical control by the voltage. For example, but not limited to, in a case where the light modulation layer 30 is formed of a ferroelectric liquid crystal, when the spatial light modulator 10 operates, half (VDD/2) of an operating voltage (VDD) applied to the driving switch circuit 70 is constantly applied to the transparent electrode 50. Meanwhile, either the same voltage as the operating voltage (VDD) or a reference voltage (GND) is applied to the pixel electrode 90 by the switch of the driving switch circuit 70, and thus the optical characteristics of the light modulation layer 30 are modulated.

In addition, the spatial light modulator 10 can modulate only a part of spatial distribution of light, such as amplitude, phase, propagation direction, intensity, and polarization plane. For example, the spatial light modulator 10 can be a spatial light phase modulator that modulates only a phase of light.

In addition, a light output type of the spatial light modulator 10 can be arbitrarily selected according to purpose or use of the spatial light modulator 10, and can be a transmissive type or a reflective type.

In addition, in a case where the light output type of the spatial light modulator 10 is the reflective type, a reflection enhancement layer formed of aluminum or the like can be placed between the pixel electrode 90 and the alignment layer 40 arranged on the side of the light modulation layer 30 opposite to the cover glass side. By forming the reflection enhancement layer, the modulation efficiency of the spatial light modulator 10 can be improved. In addition, the reflection enhancement layer can be one that has undergone a passivation treatment such as an oxide film formation. By performing the passivation treatment on the reflection enhancement layer, corrosion of the reflection enhancement layer can be prevented.

In addition, the spatial light modulator 10 of the present disclosure can be used for purpose other than hologram reproduction. For example, the spatial light modulator 10 can be used for a 3D printer or a laser processing beam, but not limited thereto.

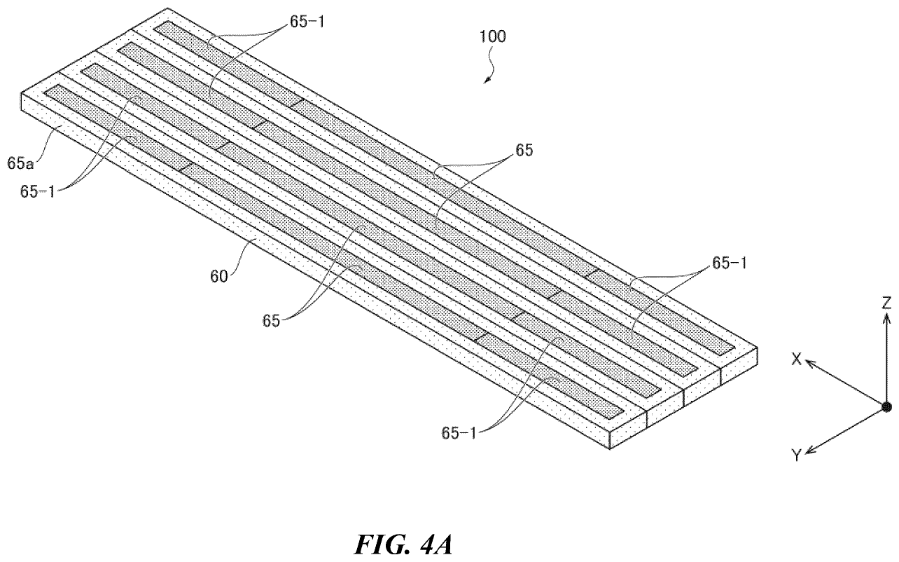

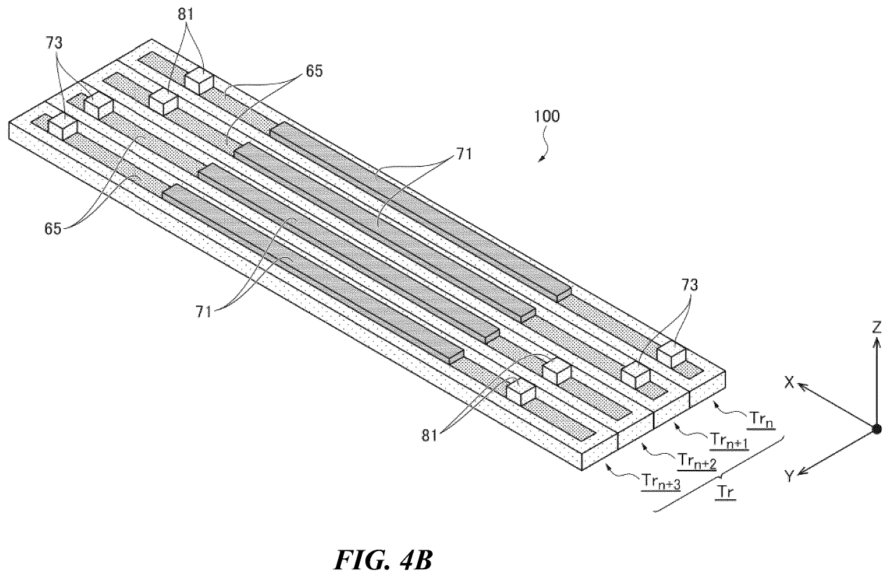

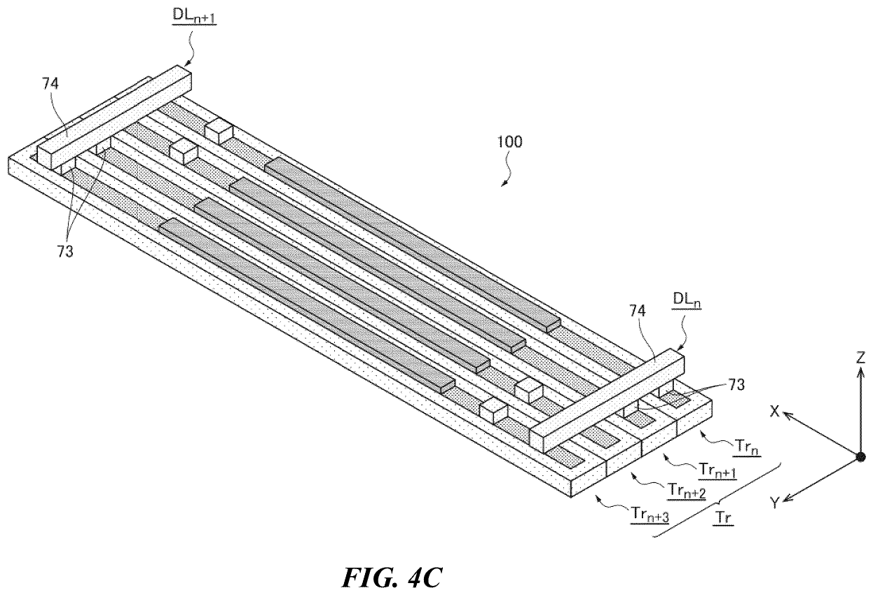

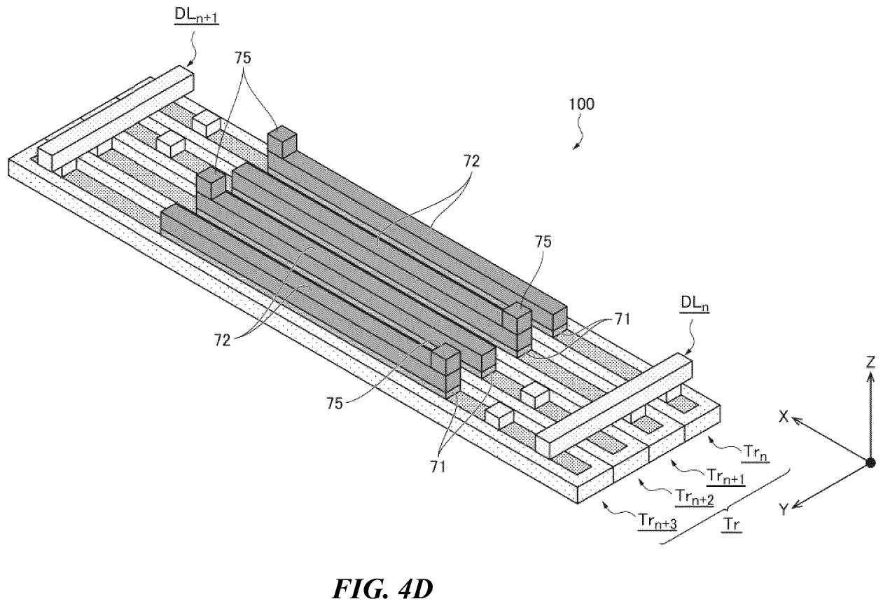

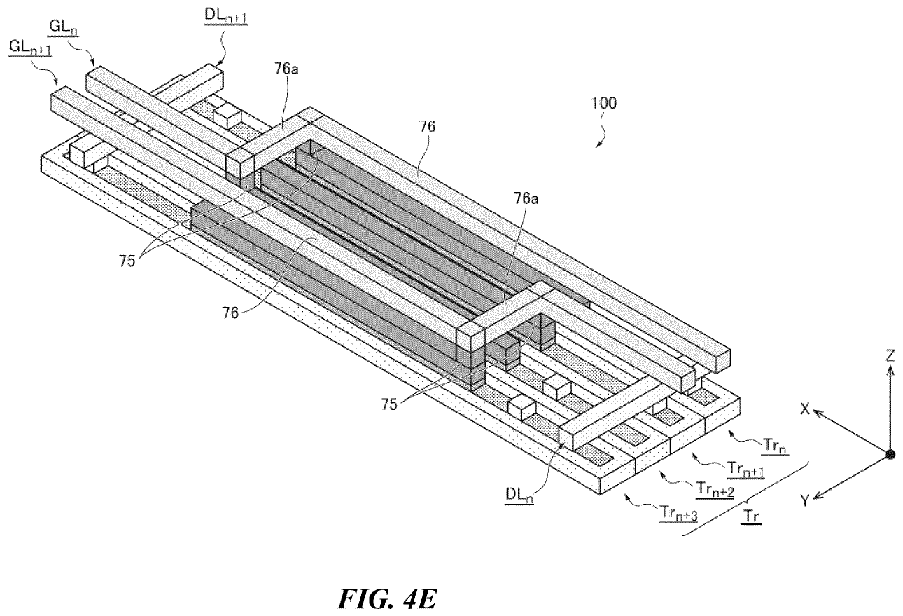

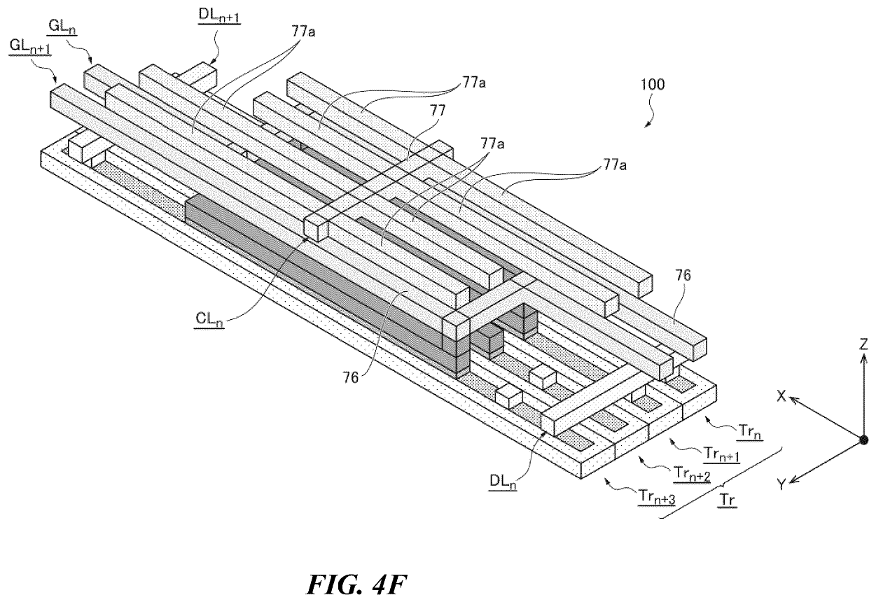

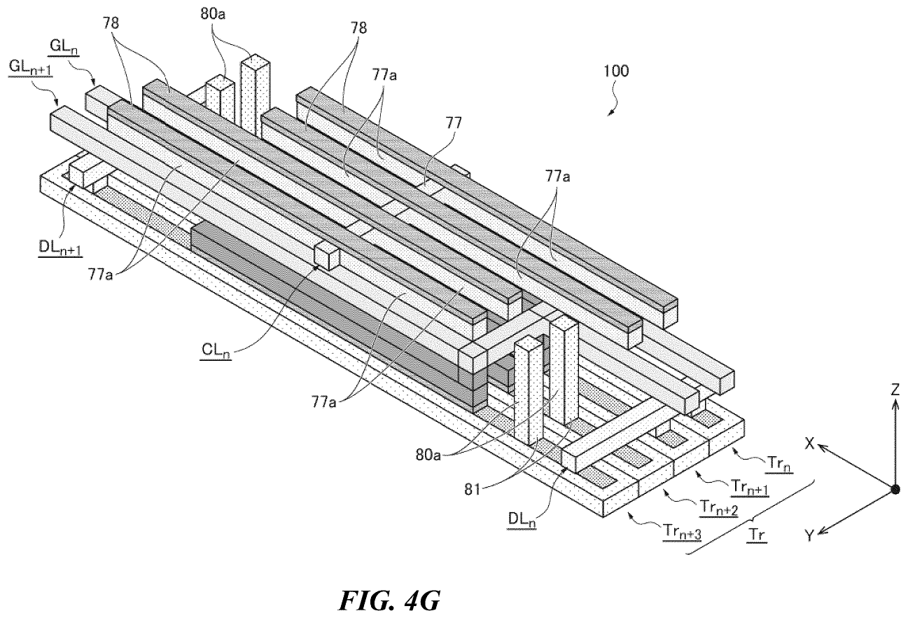

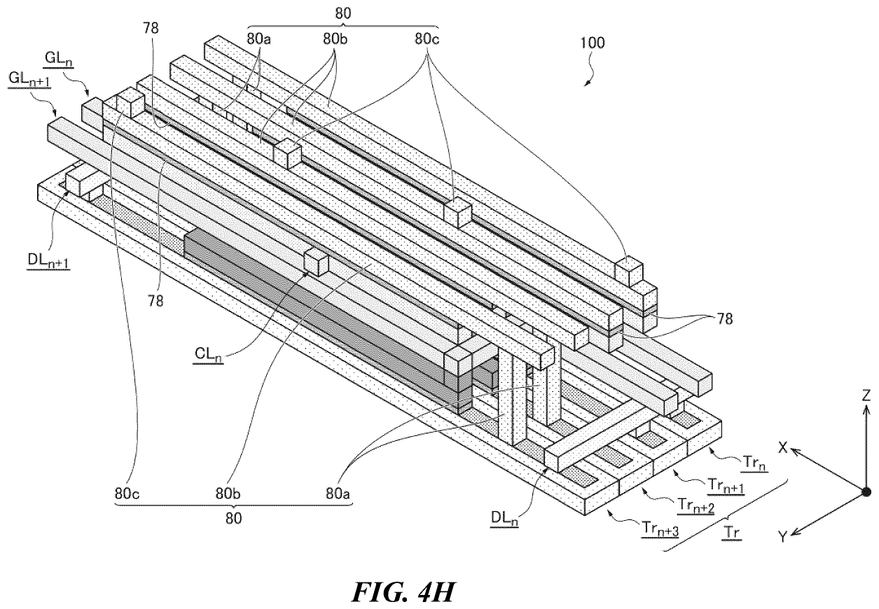

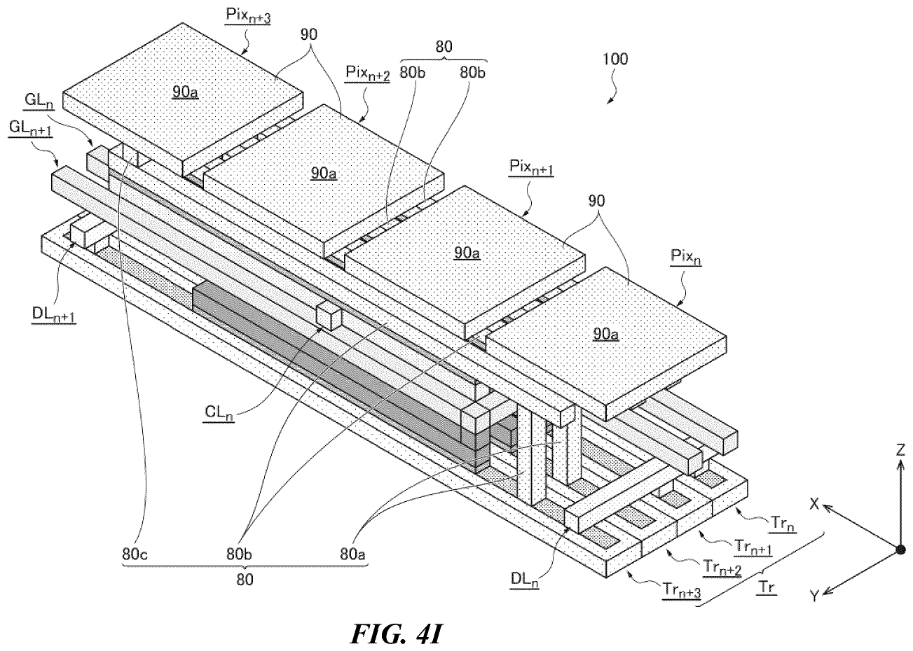

Hereinafter, the pixel circuit substrate 100 according to an embodiment is described with reference to FIGS. 4A to 4I. The pixel circuit substrate 100 can be manufactured, for example, by using a 3D printer or the like in at least some processes.

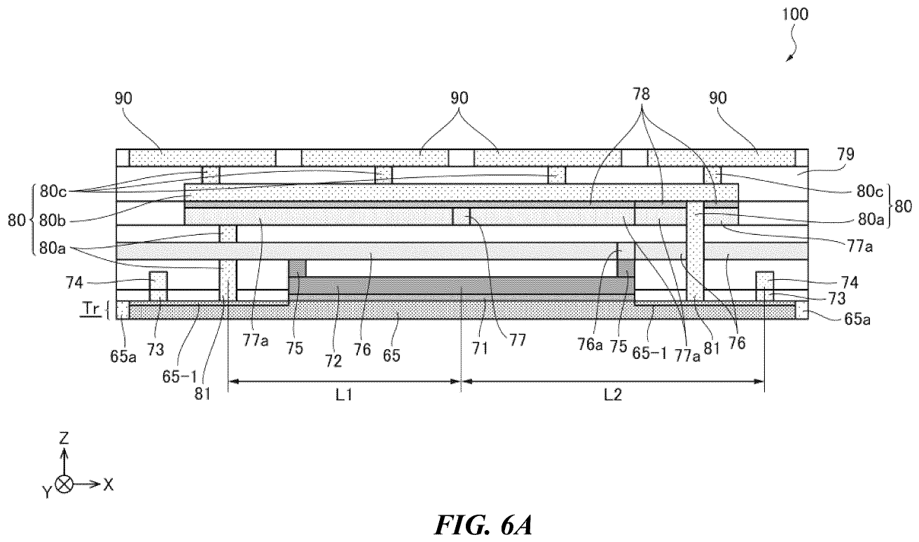

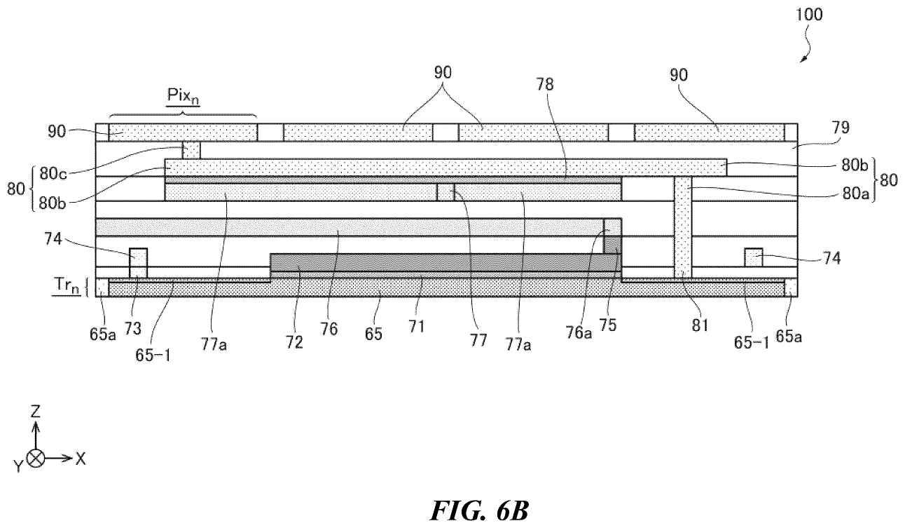

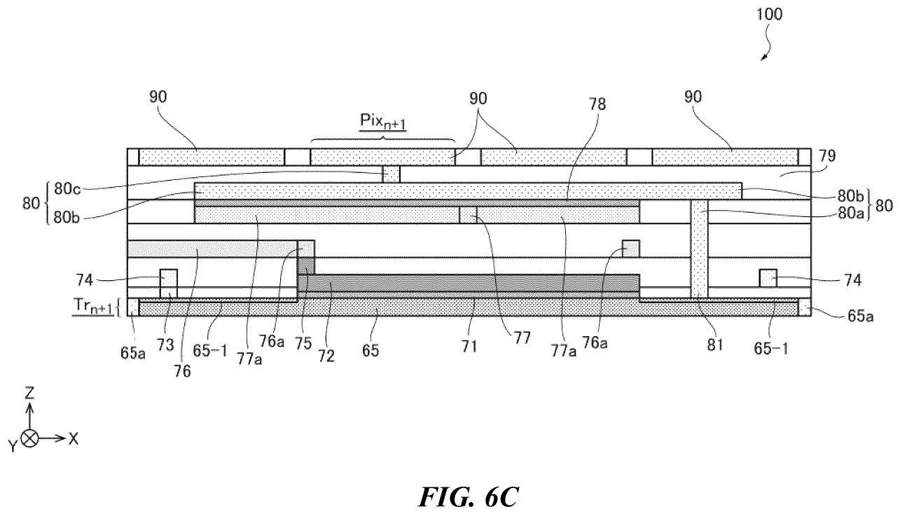

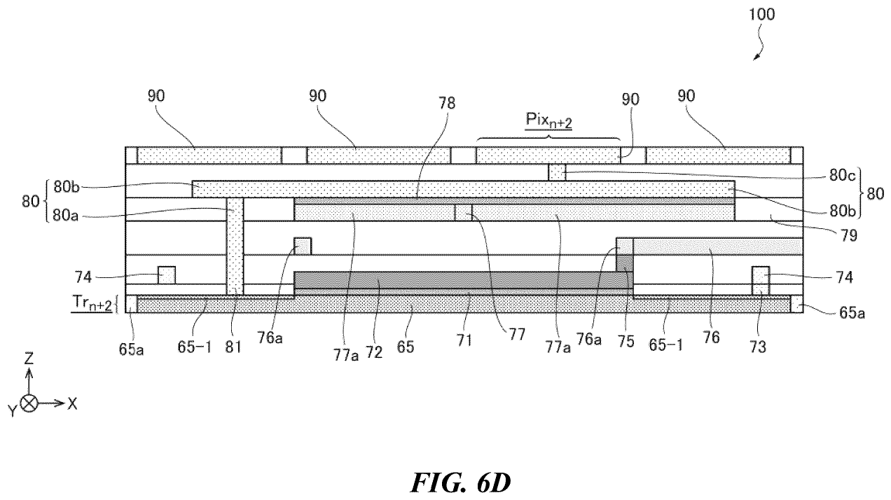

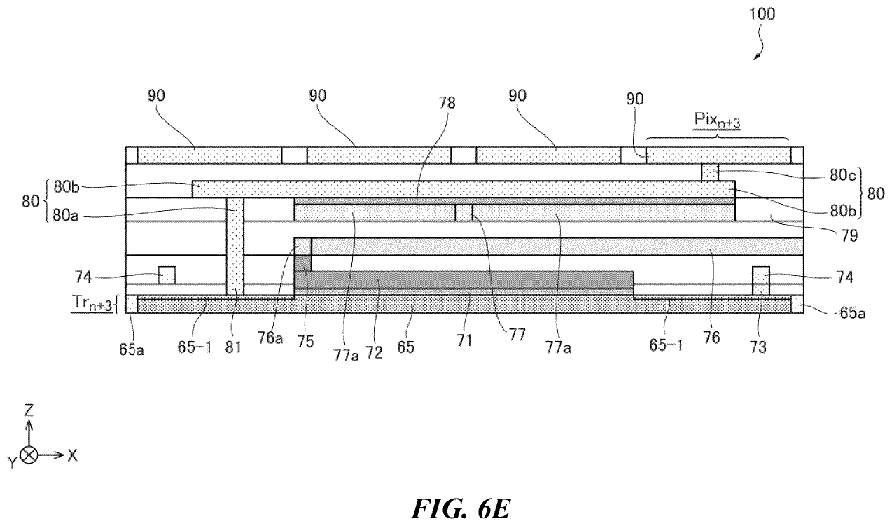

In addition, FIGS. 4A to 4I are intended to facilitate understanding of a configuration of the pixel circuit substrate 100, and although each component is appropriately added and explained in the order of FIGS. 4A to 4I, FIGS. 4A to 4I do not disclose the manufacturing order of the pixel circuit substrate 100. In addition, although gaps between components of the pixel circuit substrate 100 are filled with an insulating material (79, see FIGS. 6A to 6E), in FIGS. 4A to 4I, the insulating material 79 is not illustrated for the purpose of clarifying an internal structure. In addition, in the drawings illustrating the pixel circuit substrate 100 including FIGS. 4A to 4I, there are parts where a boundary line is illustrated even within the same member, but it is not necessarily intended that a boundary exists. In addition, in the drawings that follow, X, Y, and Z axes are described for convenience of explanation, and the pixel circuit substrate 100 exists in a position where X, Y, and Z are all positive (e.g., a first quadrant with respect to XY plane), but this does not limit the arrangement of the actual pixel circuit substrate 100 in the spatial light modulator 10.

As shown in FIG. 4A, the substrate 60 includes a plurality of active layer regions 65 extending in one direction. The plurality of active layer regions 65 are arranged with a gap between each other in a direction intersecting the extension direction of the active layer regions 65. At ends of the active layer region 65 in the direction in which the active layer region 65 extends, doping region 65-1 doped with an impurity such as boron or phosphorus are formed depending on purpose or use of the pixel circuit substrate 100.

It is preferable that the active layer region 65 be formed of a single crystal material. By forming the active layer region 65 with a single crystal material, the active layer region 65 with higher purity and regular atomic arrangement compared to a polycrystalline material can be formed, thereby reducing an electrical resistance value and reducing an error in the electrical characteristics including the electrical resistance values of the active layer regions 65. In addition, by forming the active layer region 65 with a single crystal material, the active layer region 65 with regular atomic arrangement compared to a polycrystalline material can be formed, thereby improving mobility of electrons or holes in the active layer region 65.

In addition, it is more preferable that the active layer region 65 be formed with a single crystal material selected from a group consisting of Si, SiC, GaN, and Ga2O3. By forming the active layer region 65 with the above single crystal material, a power conversion efficiency in the pixel circuit 150 can be improved while improving a voltage withstand capability.

A trench insulation portion 65a is formed on an outer periphery of each active layer region 65. The material of the trench insulation portion 65a can be selected from any material depending on purpose or use of the pixel circuit substrate 100, and uses, for example, but not limited to, an insulator such as SiO2. The trench insulation portion 65a is formed, for example, by a shallow trench isolation (STI) method. In addition, the trench insulation portion 65a can be formed by other methods depending on purpose or use of the pixel circuit substrate 100, but it is preferable to adopt a method that can realize making the active layer region 65 fine. In addition, the trench insulation portion 65a can adopt an insulation structure other than the trench type as long as the adjacent active layer regions 65 can be electrically insulated.

In addition, in FIG. 4A, the plurality of active layer regions 65 are aligned at intervals in the direction (e.g., a positive direction of the Y axis) orthogonal to the direction in which the active layer regions 65 extends (e.g., a positive direction of the X axis), but not limited thereto. For example, the plurality of active layer regions 65 can be arranged diagonally so that a line connecting a center of each active layer region 65 forms an angle with the positive direction of the Y axis.

In addition, in FIG. 4A, a shape of the active layer region 65 is a rectangular shape with a large aspect ratio, but any shape can be selected according to purpose or use of the pixel circuit substrate 100. For example, a shape of the active layer region 65 can be an oval.

As shown in FIGS. 4B to 4D, the pixel circuit substrate 100 includes an insulating layer 71. The insulating layer 71 is arranged at a center portion of each active layer region 65 and extends along the direction in which the active layer region 65 extends (e.g., the positive direction of the X axis). As a material of the insulating layer 71, any material can be selected according to purpose or use of the pixel circuit substrate 100. The insulating layer 71 uses, for example, but not limited to, an insulator such as SiO2 or SiOXNy (silicon oxynitride).

In addition, as shown in FIG. 4D, the pixel circuit substrate 100 includes a scan terminal 72. The scan terminal 72 is arranged with the insulating layer 71 between each active layer region 65 and the scan terminal 72. The scan terminal 72 extends in the same direction as the insulating layer 71 and covers the insulating layer 71. The scan terminal 72 forms one of two input terminals of the driving switch circuit 70.

In addition, as shown in FIG. 4B, the pixel circuit substrate 100 includes a data terminal 73 and a control terminal 81. The data terminal 73 and the control terminal 81 are arranged at the respective doping regions 65-1 of each active layer region 65. The data terminal 73 forms the other of the two input terminals of the driving switch circuit 70. The control terminal 81 forms an output terminal of the driving switch circuit 70.

The material of the scan terminal 72, the data terminal 73, and the control terminal 81 can be selected from any material depending on purpose or use of the pixel circuit substrate 100, and use, for example, but not limited to, a conductor such as aluminum or copper. In addition, in the following description, if components of the pixel circuit substrate 100 are formed of a conductor, the same material is selected unless otherwise specified.

Each active layer region 65, and the insulating layer 71, the scan terminal 72, the data terminal 73, and the control terminal 81 that are disposed on each active layer region 65 form each of a plurality of driving switches Tr.

In addition, in the following description, as shown in FIG. 4B, a n-th driving switch Trn is referred to as a driving switch Tr closest to the X axis in the first quadrant of the XYZ plane. In addition, a n+1-th driving switch Trn+1 is referred to as a driving switch Tr closest to the n-th driving switch Trn. In addition, a n+2-th driving switch Trn+2 is referred to as a driving switch Tr closest to the n+1-th driving switch Trn+1. In addition, a n+3-th driving switch Trn+3 is referred to as a driving switch Tr closest to the n+2-th driving switch Trn+2. In addition, when there is no need to specifically distinguish the n-th driving switch Trn, the n+1-th driving switch Trn+1, the n+2-th driving switch Trn+2, and the n+3-th driving switch Trn+3, they are collectively referred to as the driving switches Tr.

The driving switch Tr can be formed as any electronic component according to purpose or use of the pixel circuit substrate 100, and is formed as a transistor, for example. For example, the driving switch Tr is preferably formed as a field effect transistor (FET) such as a MOSFET. By forming the driving switch Tr as a MOSFET, the driving switch circuit 70 can be formed by a CMOS circuit capable of high-speed switching operation.

In addition, in a case where the driving switch Tr is formed as a MOSFET, the MOSFET can be an n-type MOSFET or a p-type MOSFET. In addition, the MOSFET can be an enhancement type or a depletion type. In addition, in FIGS. 4B to 4D, the insulating layer 71 is arranged on an upper surface of the active layer region 65 and the driving switch Tr is formed similar to a planar type MOSFET, but not limited thereto, and a trench type MOSFET in which the insulating layer 71 is buried in the active layer region 65 can be formed.

In addition, in a case where the driving switch Tr is formed as a transistor, the scan terminal 72 is sometimes called a gate terminal or a base terminal. In addition, the data terminal 73 and the control terminal 81 are sometimes called a source terminal and a drain terminal, or a collector terminal and an emitter terminal.

As shown in FIG. 4B, the data terminals 73 of the n-th driving switch Trn and the n+1-th driving switch Trn+1 are arranged in substantially the same column along the direction in which the respective active layer regions 65 are arranged (e.g., the positive direction of the Y axis). Meanwhile, the data terminals 73 of the n+2-th driving switch Trn+2 and the n+3-th driving switch Trn+3 are arranged in substantially the same column, which is a different column from the column of the data terminal 73 of the n-th driving switch Trn, along the direction in which the respective active layer regions 65 are arranged. In addition, the control terminals 81 of the n-th driving switch Trn and the n+1-th driving switch Trn+1 are arranged in substantially the same column, which is a different column from the two columns of the above-described data terminals 73, along the direction in which the respective active layer regions 65 are arranged. Meanwhile, the control terminals 81 of the n+2-th driving switch Trn+2 and the n+3-th driving switch Trn+3 are arranged in substantially the same column, which is a different column from the above-described two columns of the data terminals 73 and from the above-described column of the control terminal 81 of the n-th driving switch Trn, along the direction in which the respective active layer regions 65 are arranged.

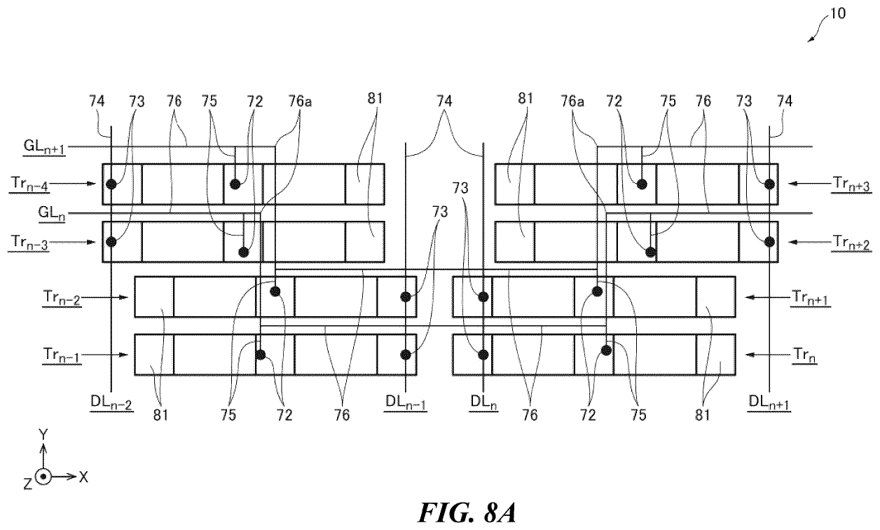

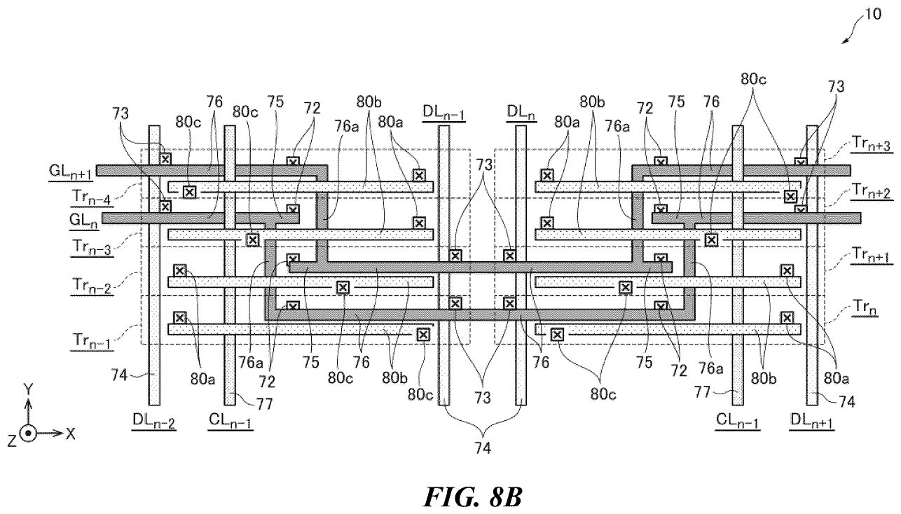

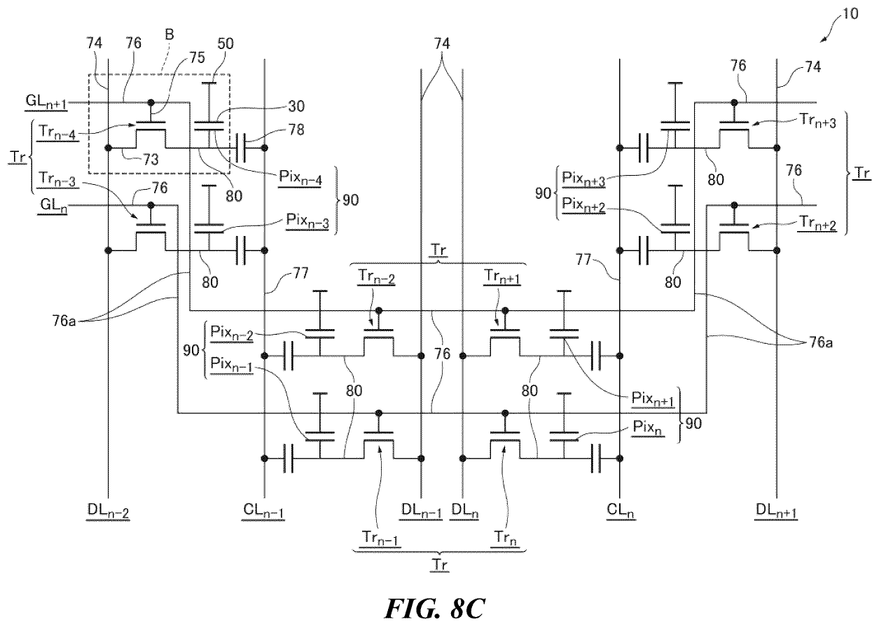

As described later with reference to the drawings after FIG. 8A, the arrangement example of the data terminals 73 and the control terminals 81 described in FIG. 4B are only a preferred example, but not limited thereto. The data terminal 73 and the control terminal 81 can each be placed in either of the doping regions 65-1 on each active layer region 65 depending on purpose or use of the pixel circuit substrate 100.

As shown in FIG. 4C, the pixel circuit substrate 100 includes a n-th data line DLn and a n+1-th data line DLn+1. The n-th data line DLn is connected to the data terminals 73 of the n-th driving switch Trn and the n+1-th driving switch Trn+1. The n+1-th data line DLn+1 is connected to the data terminals 73 of the n+2-th driving switch Trn+2 and the n+3-th driving switch Trn+3. The n-th data line DLn and the n+1-th data line DLn+1 extend across the respective active layer regions 65 along the direction in which the respective active layer regions 65 are arranged (e.g., the positive direction of the Y axis). In the following description, when there is no need to specifically distinguish between them, the n-th data line DLn and the n+1-th data line DLn+1 are collectively referred to as data lines 74. The n-th data line DLn and the n+1-th data line (DLn+1) are formed of a conductor.

In addition, in FIG. 4C, the data line 74 is formed separately from the data terminal 73, but they can be formed integrally. A cross-section of the data line 74 can be selected in any shape depending on purpose or use of the pixel circuit substrate 100, and can be, for example, rectangular or circular, but not limited thereto. In addition, for the purpose of reducing electric resistance and capacitance of the data line 74, an auxiliary conductor line can be formed in a different layer from the data line 74 and parallel to the data line 74 while a portion of the auxiliary conductor line is in contact with the data line 74.

In addition, a word ‘line’ of the data line (74) does not limit thickness or diameter of the data line 74. The thickness or diameter of the data line 74 can be any numerical value depending on purpose or use of the pixel circuit substrate 100.

As shown in FIG. 4D, the pixel circuit substrate 100 includes scan terminal lines 75. Each scan terminal line 75 is connected to each scan terminal 72. Each scan terminal line 75 extends in a direction away from the active layer region 65 with the scan terminal 72 as a starting point (e.g., in a positive direction of the Z axis). The scan terminal lines 75 are formed of a conductor.

The scan terminal lines 75 of the n-th driving switch Trn and the n+2-th driving switch Trn+2 are arranged in substantially the same column along the direction in which the respective active layer regions 65 are arranged (e.g., the positive direction of the Y axis). The scan terminal lines 75 of the n+1-th driving switch Trn+1 and the n+3-th driving switch Trn+3 are arranged in substantially the same column which is a different column from the column of the data terminal 73 of the n-th driving switch Trn, along the direction in which the respective active layer regions 65 are arranged (e.g., the positive direction of the Y axis).

The arrangement example of the scan terminal lines 75 described in FIG. 4D is only a preferred example, but not limited thereto. The scan terminal line 75 can be arranged at any position depending on purpose or use of the pixel circuit substrate 100. For example, the scan terminal line 75 can be formed outside the active layer region 65 by extending the scan terminal 72.

In addition, in FIG. 4D, the scan terminal line 75 is formed separately from the scan terminal 72, but they can be formed integrally. A cross-section of the scan terminal line 75 can have any shape depending on purpose or use of the pixel circuit substrate 100, and can have, for example, but not limited to, a rectangular shape or a circular shape.

In addition, a word ‘line’ of the scan terminal line 75 does not limit thickness or diameter of the scan terminal line 75. The thickness or diameter of the scan terminal line 75 can be any numerical value depending on purpose or use of the pixel circuit substrate 100. As shown in FIG. 4E, the pixel circuit substrate 100 includes a n-th scan line GLn and a n+1-th scan line GLn+1. The n-th scan line GLn is connected to the scan terminal lines 75 of the n-th driving switch Trn and the n+2-th driving switch Trn+2. The n+1-th scan line GLn+1 is connected to the scan terminal lines 75 of the n+1-th driving switch Trn+1 and the n+3-th driving switch Trn+3. In the following description, if there is no need to specifically distinguish them, the n-th scan line GLn and the n+1-th scan line GLn+1 are collectively referred to as scan lines 76. The scan lines 76 are formed of a conductor.

The scan line 76 includes a wiring segment 76a that extends, along the direction in which the active layer regions 65 are arranged (e.g., the positive direction of the Y-axis), across the adjacent active layer regions 65. The wiring segment 76a of the n-th scan line GLn is connected to the scan terminal lines 75 of the n-th driving switch Trn and the n+2-th driving switch Trn+2. The wiring segment 76a of the n+1-th scan line GLn+1 is connected to the scan terminal lines 75 of the n+1-th driving switch Trn+1 and the n+3-th driving switch Trn+3.

One side portion of a remaining wiring of the n-th scan line GLn extends along the active layer region 65 of the n-th driving switch Trn with a point, at which the wiring segment 76a is connected to the scan terminal line 75 of the n-th driving switch Trn, as a starting point. In addition, the one side portion of the remaining wiring of the n-th scan line GLn extends toward the n-th data line DLn so as to span the n-th data line DLn with a gap therebetween in the direction away from the active layer region 65 of the n-th driving switch Trn (e.g., the positive direction of the Z axis).

The other side portion of the remaining wiring of the n-th scan line GLn extends along the active layer region 65 of the n+2-th driving switch Trn+2 with a point, at which the wiring segment 76a is connected to the scan terminal line 75 of the n+2-th driving switch Trn+2, as a starting point. In addition, the other side portion of the remaining wiring of the n-th scan line GLn extends toward the n+1-th data line DLn+1 so as to span the n+1-th data line DLn+1 with a gap therebetween in the direction away from the active layer region 65 of the n+2-th driving switch Trn+2 (e.g. the positive direction of the Z axis).

One side portion of a remaining wiring of the n+1-th scan line GLn+1 extends along the active layer region 65 of the n+1-th driving switch Trn+1 with a point, at which the wiring segment 76a is connected to the scan terminal line 75 of the n+1-th driving switch Trn+1, as a starting point. In addition, the one side portion of the remaining wiring of the n+1-th scanning line GLn+1 extends toward the n-th data line DLn so as to span the n-th data line DLn with a gap therebetween in the direction away from the active layer region 65 of the n+1-th driving switch Trn+1 (e.g., the positive direction of the Z axis).

The other side portion of the remaining wiring of the n+1-th scan line GLn+1 extends along the active layer region 65 of the n+3-th driving switch Trn+3 with a point, at which the wiring segment 76a is connected to the scan terminal line 75 of the n+3-th driving switch Trn+3, as a starting point. In addition, the other side portion of the remaining wiring of the n+1-th scan line GLn+1 extends toward the n+1-th data line DLn+1 so as to span the n+1-th data line DLn+1 in the direction away from the active layer region 65 of the n+3-th driving switch Trn+3 (e.g., the positive direction of the Z axis).

In addition, in FIG. 4E, the wiring segment 76a is formed separately from the scan terminal line 75, but they can be formed integrally. In addition, a cross-section of the scan line 76 and the wiring segment 76a can be selected in any shape depending on purpose or use of the pixel circuit substrate 100, and can have, for example, but not limited to, a rectangular shape or a circular shape.

In addition, a word ‘line’ of the scan line 76 and its wiring segment 76a does not limit thickness or diameter of the scanning line 76 and its wiring segment 76a. The thickness or diameter of the scan line 76 and its wiring segment 76a can be any numerical value depending on purpose or use of the pixel circuit substrate 100.

As shown in FIG. 4F, the pixel circuit substrate 100 includes a n-th common potential line CLn. The n-th common potential line CLn is arranged apart from the scan line (76) in the direction away from the active layer region 65 (e.g. the positive direction of the Z axis). The n-th common potential line CLn has a center position with respect to the direction in which the active layer region 65 extends (e.g., the positive direction of the X axis), and the n-th common potential line CLn at the center position extends along the direction in which the respective active layer regions 65 are arranged (e.g., the positive direction of the Y axis). The n-th common potential line CLn is collectively referred to as a common potential line 77. The common potential line 77 is formed of a conductor.

In addition, the pixel circuit substrate 100 includes a plurality of branch lines 77a connected to the common potential line 77. The plurality of branch lines 77a are arranged apart from the scan line 76 in the direction away from the active layer region 65 (e.g., the positive direction of the Z axis). Two of the plurality of branch lines 77a extend along the active layer region 65 of the n-th driving switch Trn to both sides of the common potential line 77 with the common potential line 77 as a base line. Other two of the plurality of branch lines 77a extend along the active layer region 65 of the n+1-th driving switch Trn+1 to both sides of the common potential line 77 with the common potential line 77 as a base line. Other two of the plurality of branch lines 77a extend along the active layer region 65 of the n+2-th driving switch Trn+2 to both sides of the common potential line 77 with the common potential line 77 as a base line. Other two of the plurality of branch lines 77a extend along the active layer region 65 of the n+3-th driving switch Trn+3 to both sides of the common potential line 77 with the common potential line 77 as a base line. The plurality of branch lines 77a are formed of a conductor.

In addition, in FIG. 4F, the common potential line 77 and the plurality of branch lines 77a are formed separately, but they can be formed integrally. In addition, a cross-section of the common potential line 77 and the plurality of branch lines 77a can be selected in any shape depending on purpose or use of the pixel circuit substrate 100, and can have, for example, but not limited to, a rectangular or circular shape.

In addition, a word ‘line’ of the common potential line 77 and the plurality of branch lines 77a does not limit thickness or diameter of the common potential line 77 and the plurality of branch lines 77a. The thickness or diameter of the common potential line 77 and the plurality of branch lines 77a can be any numerical value depending on purpose or use of the pixel circuit substrate 100.

As shown in FIG. 4G, the pixel circuit substrate 100 includes control terminal lines 80a. Each control terminal line 80a is connected to each control terminal 81 and extends from each control terminal 81 in the direction away from each active layer region 65 (e.g., the positive direction of the Z axis).

In addition, the control terminal line 80a can be formed separately from the control terminal 81 or can be formed integrally with the control terminal 81. In addition, in a case where the control terminal line 80a is formed integrally with the control terminal 81, they can be combined and called a control terminal line 80a. In addition, conversely, they can be called a control terminal 81. A cross-section of the control terminal line 80a can be selected in any shape depending on purpose or use of the pixel circuit substrate 100, and can have, for example, but not limited to, a rectangular shape or a circular shape. In addition, a word ‘line’ of the control terminal line 80a does not limit thickness or diameter of the control terminal line 80a. The thickness or diameter of the control terminal line 80a can be any numerical value depending on purpose or use of the pixel circuit substrate 100.

As shown in FIGS. 4G and 4H, the pixel circuit substrate 100 includes auxiliary capacitance dielectrics 78, relay lines 80b, and electrode lines 80c.

The auxiliary capacitance dielectric 78 is arranged in layer so as to cover the branch line 77a extending in the same direction (e.g., the positive direction of the X axis) in which each active layer region 65 extends, and a part of the common potential line 77 in the direction in which the branch line 77a extends. The auxiliary capacitance dielectric 78 functions as a buffer that enables a control output information of the pixel circuit substrate 100 to be maintained for a certain period of time. As a material of the auxiliary capacitance dielectric 78, any material can be selected depending on purpose or use of the pixel circuit substrate 100, and for example, a dielectric such as SiO2, aluminum, or tantalum oxide can be used, but not limited thereto.

As shown in FIG. 4H, the relay line 80b and the electrode line 80c form a control line 80 together with the control terminal line 80a. The relay line 80b and the electrode line 80c are formed of a conductor.

Each relay line 80b is connected to a tip of each control terminal line 80a in the direction in which the control terminal line 80a extends. The relay line 80b extends from the tip of the control terminal line 80a in the direction in which the branch line 77a extends. The relay line 80b is arranged so as to interpose the auxiliary capacitance dielectric 78 between the relay line 80b, and the common potential line 77 and the branch line 77a in the direction in which the branch line 77a extends. By interposing the auxiliary capacitance dielectric 78 between the relay line 80b, and the common potential line 77 and the branch line 77a, the auxiliary capacitance dielectric 78 functions as a capacitor, and the control output information of the pixel circuit substrate 100 can be maintained for a certain period of time. In addition, in FIG. 4H, a single-layered capacitor is configured by interposing one capacitance dielectric between two conductors, but a laminated capacitor in which more capacitance dielectrics and conductors are laminated can be configured, as described later.

Each electrode line 80c is connected to each relay line 80b and extend along a direction away from the relay line 80b in a direction away from the active layer region 65 (e.g., the positive direction of the Z axis). The electrode line 80c can be arranged at any position of the relay line 80b depending on an arrangement position of the pixel electrode 90. In FIG. 4H, the electrode lines 80c are arranged diagonally with respect to the direction in which the active layer region 65 extends, such that a line connecting centers of the electrode lines 80c is away from the direction in which the active layer region 65 extends (e.g., the positive direction of the X axis).

In addition, in FIG. 4H, the control terminal line 80a, the relay line 80b, and the electrode line 80c are formed separately from one another, but some or all of them can be formed integrally. In addition, a cross-section of the control terminal line 80a, the relay line 80b, and the electrode line 80c can be selected in any shape depending on purpose or use of the pixel circuit substrate 100, and can have, for example, but not limited to, a rectangular or circular shape.

In addition, a word ‘line’ of the control terminal line 80a, the relay line 80b, and the electrode line 80c does not limit thickness or diameter of the control terminal line 80a, the relay line 80b, and the electrode line 80c. The thickness or diameter of the control terminal line 80a, the relay line 80b, and the electrode line 80c can be any numerical value depending on purpose or use of the pixel circuit substrate 100.

As shown in FIG. 4I, the pixel circuit substrate 100 includes a plurality of pixel electrodes 90. Each pixel electrode 90 includes a pixel surface 90a that defines a pixel of the spatial light modulator 10. Each pixel electrode 90 is connected to each electrode line 80c at a surface opposite to the pixel surface 90a.

A material of the pixel electrode 90 can be any conductive material selected according to purpose or use of the pixel circuit substrate 100. The material of the pixel electrode 90 is not limited, but uses, for example, a conductor such as aluminum, copper, indium tin oxide (ITO) (e.g., index-matching ITO (IMITO)), tin oxide, magnesium-silver alloy, or polythiophene-based conductive polymer using PEDOT (polyethylene dioxythiophene).

In the pixel circuit substrate 100, the plurality of pixel electrodes 90 are arranged with a gap between them along the direction in which the active layer region 65 extends (e.g., the X axis direction). In addition, in FIG. 4I, the plurality of pixel electrodes 90 are arranged with a gap in the same direction as the direction in which the active layer region 65 extends (e.g., the positive direction of the X-axis), but not limited thereto. For example, the plurality of pixel electrodes 90 can be arranged diagonally so that a line connecting centers of the respective pixel electrodes 90 forms an angle with the positive direction of the X axis. In addition, the gap between the pixel electrodes 90 is preferably constant in that it can reduce a load of hologram operation, but the gap can be random. In a case where the gap between the pixel electrodes 90 is random, for example, a hologram can be operated by machine learning of a correlation between input data for the spatial light modulator 10 and comparison of the reproduced stereoscopic image.

In addition, in FIG. 4I, a shape of the pixel electrode 90 is rectangular, but any shape can be selected according to purpose or use of the pixel circuit substrate 100. For example, the shape of the pixel electrode 90 may be a circular shape, an oval shape, or a polygonal shape other than a rectangular shape. In addition, the shapes of all pixel electrodes 90 may not necessarily be the same shape, but when considering ease of arrangement, it is preferable that they be the same shape.

In addition, the shape of the pixel electrode 90 is preferably rectangular. By making the shape of the pixel electrode 90 rectangular, the gap between the adjacent pixel electrodes 90 can be reduced, so that an aperture ratio in the light modulation region of the spatial light modulator 10 can be improved.

In addition, the shape of the pixel electrode 90 is more preferably a square shape. In addition, by making the shape of the pixel electrode 90 a square shape, the gap between adjacent pixel electrodes 90 can be reduced, while increasing a number of pixels in the light modulation region of the spatial light modulator 10. Therefore, by making the shape of the pixel electrode 90 square, the aperture ratio in the light modulation region of the spatial light modulator 10 can be improved, while making the pixel fine in the light modulation region of the spatial light modulator 10 can be secured.

In addition, as shown in FIG. 4I and FIG. 6B described later, a n-th pixel electrode Pixn is connected to the n-th driving switch Trn through the control line 80. In addition, as shown in FIG. 4I and FIG. 6C described later, a n+1-th pixel electrode Pixn+1 is connected to the n+1-th driving switch Trn+1 through the control line 80. In addition, as shown in FIG. 4I and FIG. 6D described later, a n+2-th pixel electrode Pixn+2 is connected to the n+2-th driving switch Trn+2 through the control line 80. In addition, as shown in FIG. 4I and FIG. 6E described later, a n+3-th pixel electrode Pixn+3 is connected to the n+3-th driving switch Trn+3 through the control line 80. The n-th pixel electrode Pixn, the n+1-th pixel electrode Pixn+1, the n+2-th pixel electrode Pixn+2, and the n+3-th pixel electrode Pixn+3 are collectively referred to as pixel electrodes 90 when there is no need to specifically distinguish them.

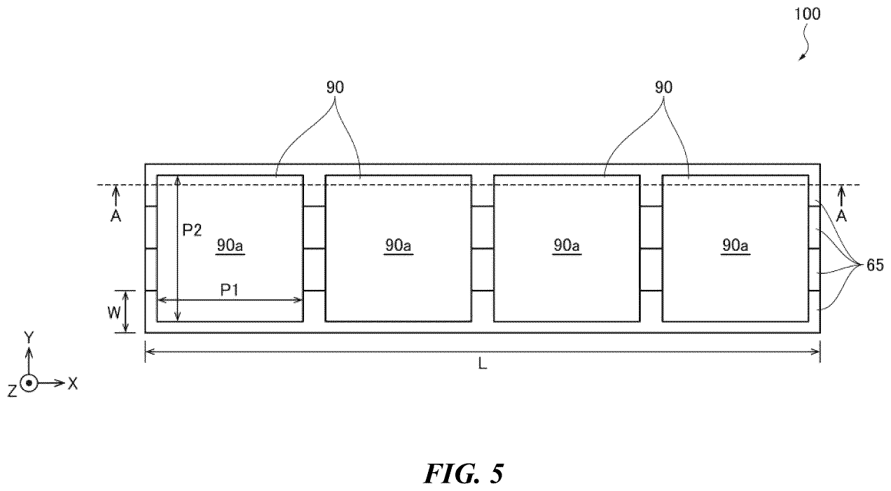

As shown in FIG. 4I and FIG. 5, each active layer region 65 is arranged at a distance from each pixel electrode 90 at a position overlapping the pixel surface 90a.

In addition, the plurality of active layer regions 65 are extended across adjacent pixel electrodes 90 at positions overlapping the pixel surfaces 90a of the plurality of pixel electrodes 90. In other words, as shown in FIG. 4I and FIG. 5, in the extension direction (e.g., the X axis direction) of the active layer region 65, a length L of the active layer region 65 is longer than a width P1 of the pixel surface 90a.

For example, a viewing angle (2θmax) at which hologram reproduction is possible is expressed by the following equation when a wavelength is a variable λ and a pixel pitch is a variable p.

2θmax=2 sin⁻¹[λ/2p].

According to this equation, in order to secure the viewing angle (2θmax) required for hologram reproduction, both of the width P1 and the width P2 of the pixel surface 90a need to be as fine as a wavelength of light (e.g., less than 1 μm).

Meanwhile, in order to make the spatial light modulator 10 respond at high speed, a high voltage (e.g., 5 V or more) is required, so if the length L (i.e., the channel length) of the active layer region 65 is shortened in conjunction with making the pixel surface 90a fine, voltage withstand capability of the active layer region 65 may be reduced, causing a failure or malfunction of the driving switch Tr.

However, in the pixel circuit substrate 100 of the present disclosure, the length L of the active layer region 65 can be made longer than the width P1 of the pixel surface 90a, so that the voltage withstand capability of the active layer region 65 can be secured while promoting the pixel surface 90a being fine.

In addition, at a position where the plurality of active layer regions 65 overlap the pixel surface 90a, the plurality of active layer regions 65 are arranged to be spaced apart from each other in the direction (e.g., the Y axis direction) intersecting the arrangement direction (e.g., the X axis direction) of the plurality of pixel electrodes 90. Specifically, in the arrangement direction (e.g., the Y axis direction) of the plurality of active layer regions 65, the width W of the active layer region 65 is shorter than the width P2 of the pixel surface 90a.

If the width W of the active layer region 65 is made shorter than the width P2 of the pixel surface 90a, one pixel surface 90a can overlap the plurality of active layer regions 65, thereby improving the density of the pixel electrodes 90 connected to the plurality of active layer regions 65. Therefore, by making the width W of the active layer region 65 shorter than the width P2 of the pixel surface 90a, the aperture ratio in the light modulation region of the spatial light modulator 10 can be improved.

In addition, the respective active layer regions 65 have the same length L and the same width W, so that the electrical characteristics of the active layer region 65, such as the resistance value, can be made almost the same, which is desirable, but they can be made to have different widths.

In addition, when a number of the active layer regions 65 and a number of the pixel electrodes 90 arranged in the pixel circuit substrate 100 are plural, arbitrary quantity can be selected according to purpose or use of the pixel circuit substrate 100.

In addition, by making a spacing L1 between the scan terminal 72 and the control terminal 81 the same as a spacing L2 between the scan terminal 72 and the data terminal 73 shown in FIG. 6A, stable operation is possible regardless of a current direction of the driving switch Tr.

In FIGS. 6A to 6E, wirings, etc., in the pixel circuit substrate 100 are described. In FIGS. 6A to 6E, the same configuration as in FIGS. 4A to 4I is illustrated, except that the insulating material 79 is shown in a gap between components. The insulating material 79 uses, for example, but not limited to, SiO2.

As shown in a perspective view of FIG. 6A, the scan line 76 extends between the driving switch Tr and the pixel electrode 90 without intersecting the control line 80. In addition, as shown in FIGS. 6B to 6E, the scan line 76 extends between the driving switch Tr and the pixel electrode 90 by bypassing all the control lines 80. More specifically, the scan line 76 extends between the driving switch Tr and the relay line 80b by bypassing the control terminal line 80a of the control line 80 without intersecting the control terminal line 80a of the control line 80.

According to the above-described configuration, while securing the voltage withstand capability of the driving switch Tr, it is possible to provide the pixel circuit substrate 100 capable of wiring the scan line 76 connected to the driving switch Tr, so that the spatial light modulator 10 having fine pixels can be realized, and desirable hologram reproduction, etc., can be realized.

In addition, the scan line 76 includes the wiring segment 76a extending across the adjacent active layer regions 65, so that the bypass of the scan line 76 can be efficiently realized.

In addition, the pixel circuit substrate 100 of the present disclosure can be realized by bypassing the data line 74 instead of the scan line 76.

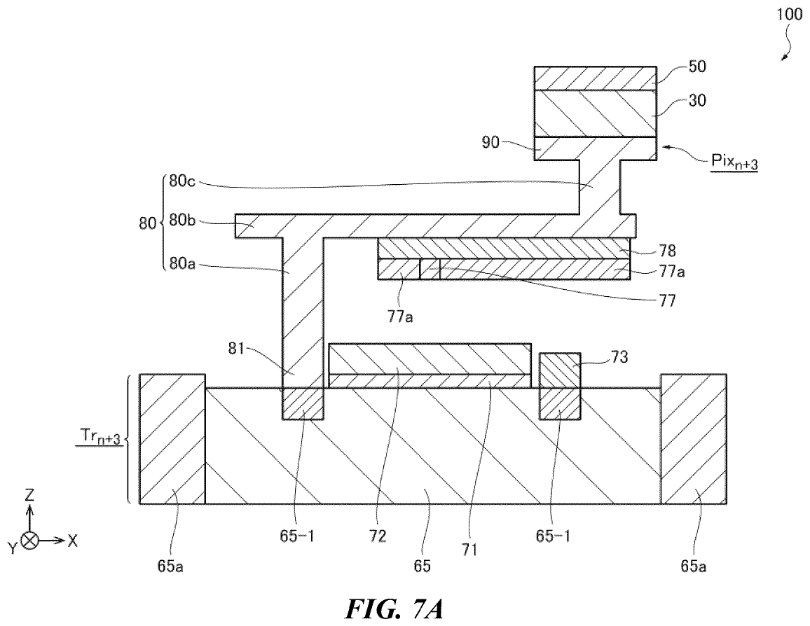

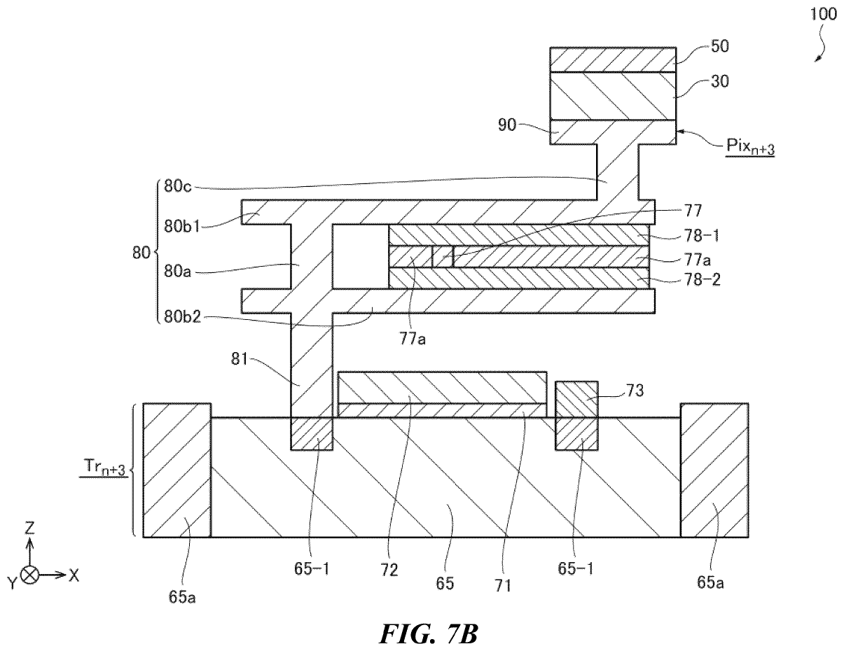

In FIG. 7A, a cross-section of the n+3-th driving switch Trn+3 is illustrated. As described above, a voltage that is half (VDD/2) of the operating voltage (VDD) of the driving switch Tr is constantly applied to the transparent electrode 50, and a voltage equal to the operating voltage (VDD) or a reference voltage (GND) is applied to the data terminal 73.

In addition, the active layer region 65 is constantly maintained at the reference voltage (GND). In addition, a voltage that is half (VDD/2) of the operating voltage (VDD) of the driving switch Tr is constantly applied to the common potential line 77 or the branch line 77a.

When the n+3-th driving switch Trn+3 is driven, a scan voltage (VG) is applied to the scan terminal 72. Thus, the operating voltage (VDD) is applied to the pixel electrode 90 when the operating voltage (VDD) is applied to the data terminal 73 and the scan voltage (VG) is applied to the scan terminal 72, and in other cases, the reference voltage (GND) is applied.

When the operating voltage (VDD) is applied to the data terminal 73 and the scan voltage (VG) is applied to the scan terminal 72, the control output information of the pixel circuit substrate 100 is maintained in the auxiliary capacitance dielectric 78 for a certain period of time.

FIG. 7B illustrates a modified example of FIG. 7A. In FIG. 7B, a first relay line 80bl and a second relay line 80b2 are formed. A first auxiliary capacitance dielectric 78-1 is formed between the first relay line 80b1, and the common potential line 77 or branch line 77a, and a second auxiliary capacitance dielectric 78-2 is formed between the second relay line 80b2, and the common potential line 77 or branch line 77a. The other structures are the same as in FIG. 7A.

According to the above-described configuration, a retention capacity of the control output information of the pixel circuit substrate 100 can be increased.

In FIGS. 8A to 8C, a circuit is illustrated in the case where the pixel circuit substrate 100 is applied to the light modulation region of the spatial light modulator 10. As shown in FIGS. 8A and 8B, a circuit region having a n−1-th driving switch Trn−1 to a n−4-th driving switch Trn−4 is configured as a mirror image of a circuit region having a n-th driving switch Trn to a n+3-th driving switch Trn+3, i.e., a circuit region of the pixel circuit substrate 100. Therefore, in the circuit region having the n−1-th driving switch Trn−1 to the n−4-th driving switch Trn−4, a mirror image of the YZ plane of the pixel circuit substrate 100 of FIG. 4I is arranged and coupled to the scan line 76. The pixel circuit substrate 100 and its mirror image form a unit circuit of the light modulation region of the spatial light modulator 10. In the light modulation region of the spatial light modulator 10, the unit circuits are repeatedly arranged in the direction in which the scan line 76 extends (e.g., the X axis direction) and in the direction in which the data line 74 and the common potential line 77 extend (e.g., the Y axis direction).

Two data lines and two scan lines are wired in the circuit region of the pixel circuit substrate 100. By independently applying voltages to the two data lines and the two scan lines, the n-th driving switch Trn to the n+3-th driving switch Trn+3 can independently perform driving and stopping.

In FIGS. 8A to 8C, the data terminals 73 of the n-th driving switch Trn and the n+1-th driving switch Trn+1 are connected to the n-th data line DLn. In addition, the data terminals 73 of the n+2-th driving switch Trn+2 and the n+3-th driving switch Trn+3 are connected to the n+1-th data line DLn+1. In addition, the control terminals 81 of the n-th driving switch Trn and the n+1-th driving switch Trn+1 are arranged close to the n+1-th data line DLn+1. In addition, the control terminals 81 of the n+2-th driving switch Trn+2 and the n+3-th driving switch Trn+3 are arranged close to the n-th data line DLn.

In a case where the control terminals 81 of the n-th driving switch Trn to the n+3-th driving switch Trn+3 are arranged almost in a column, because the control terminal line 80a extends in the Z-axis direction, there is a possibility that a wiring space of the scan line 76 cannot be secured. In contrast, in FIGS. 8A to 8C, the control terminals 81 of the n-th driving switch Trn to the n+3-th driving switch Trn+3 are not arranged in a column, so that the wiring space of the scan line 76 can be secured. In addition, as shown in FIG. 8B, since the scan line 76 has the wiring segment 76a, the bypass of the control terminal line 80a can be easily realized.

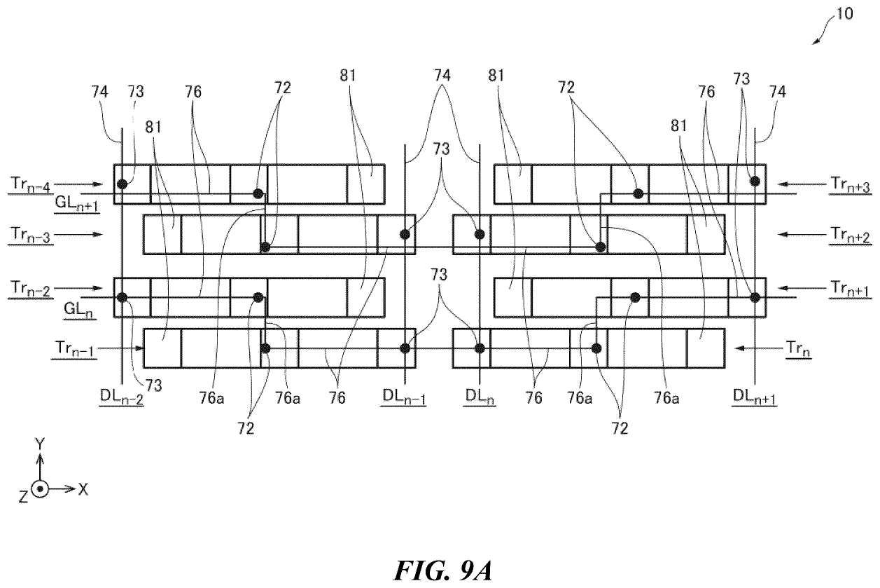

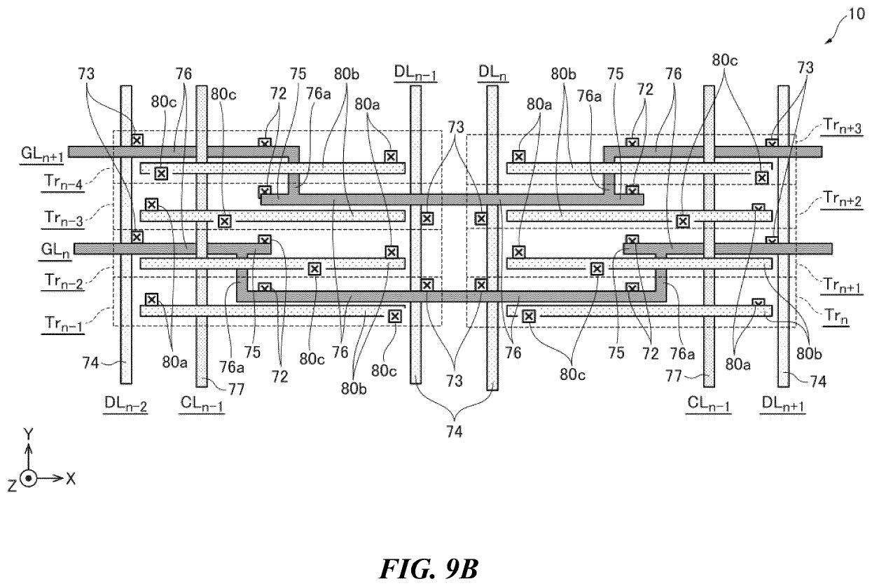

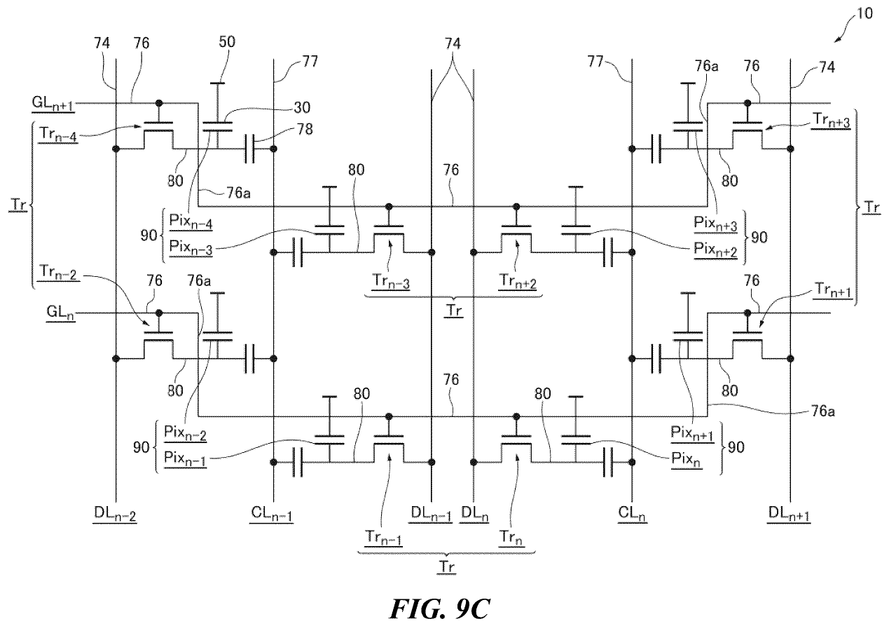

In FIGS. 9A to 9C, the data terminals 73 of the n-th driving switch Trn and the n+2-th driving switch Trn+2 are connected to the n-th data line DLn. In addition, the data terminals 73 of the n+1-th driving switch Trn+1 and the n+3-th driving switch Trn+3 are connected to the n+1-th data line DLn+1. In addition, the control terminals 81 of the n-th driving switch Trn and the n+2-th driving switch Trn+2 are arranged close to the n+1-th data line DLn+1. In addition, the control terminals 81 of the n+1-th driving switch Trn+1 and the n+3-th driving switch Trn+3 are arranged close to the n-th data line DLn. The other configurations are the same as those of FIGS. 8A to 8C.

In FIGS. 9A to 9C, since the control terminals 81 of the n-th driving switch Trn to the n+3-th driving switch Trn+3 are not arranged in a column, the wiring space of the scan line 76 can be secured. In addition, since the scan line 76 has the wiring segment 76a, the bypass of the control terminal line 80a can be easily realized. Therefore, the same effect as in FIGS. 8A to 8C is obtained.

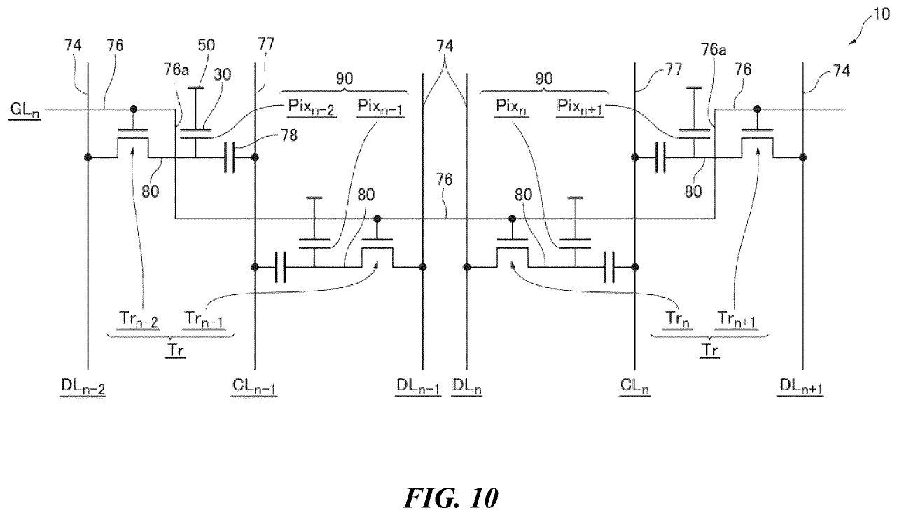

In addition, as shown in FIG. 10, the unit circuit formed from a portion including the n−2-th driving switch Trn−2 to the n+1-th driving switch Trn+1 among the unit circuit of FIGS. 9A to 9C also obtains the same effect as described above.

In addition, in the light modulation region of the spatial light modulator 10, the unit circuits of FIGS. 8A to 8C, FIGS. 9A to 9C, and FIG. 10 can be combined and used.

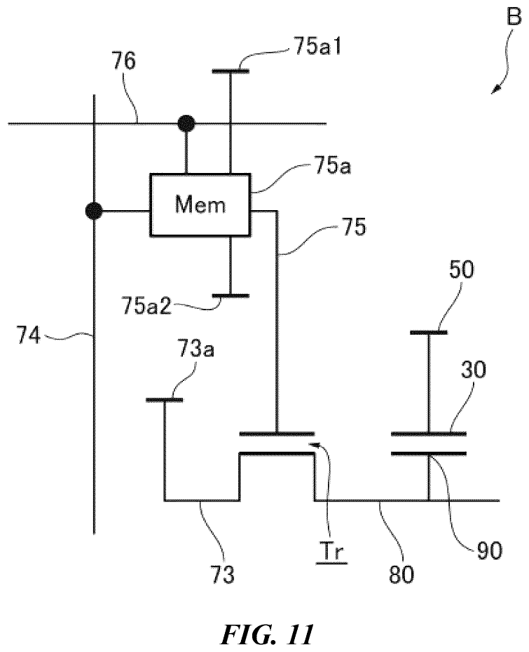

In addition, as shown in FIG. 11, the driving switch Tr can include a memory element 75a. The memory element 75a is connected to the data line 74 and the scan line 76, and can drive the driving switch Tr by transmitting an electric signal to the scan terminal line 75 based on signals from the data line 74 and the scan line 76. In a case of the configuration of FIG. 11, the operating voltage (VDD) of the driving switch Tr is constantly applied to the terminal 73a of the data terminal 73. In addition, when storing data in the memory element 75a, a positive power (e.g., VDD) of the driving switch Tr is applied to a first terminal 75al of the memory element 75a, and a negative power (e.g., VSS) of the driving switch Tr is applied to a second terminal 75a2 of the memory element 75a.

In addition, the memory element 75a can be any one according to purpose or use of the pixel circuit substrate 100. The memory element 75a is selected from, for example, DRAM, SRAM, FeRAM, or ReRAM.

According to the present disclosure, the pixel circuit substrate, the spatial light modulator, and the display system can be provided that secure the voltage withstand capability of the driving switch while enabling the arrangement of the scan line or the data line connected to the driving switch.

It will be apparent to those skilled in the art that various modifications and variation can be made in the present disclosure without departing from the spirit or scope of the disclosure. Thus, it is intended that the present disclosure cover the modifications and variations of this disclosure provided they come within the scope of the appended claims and their equivalents.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A pixel circuit substrate for a spatial light modulator, comprising:
a plurality of pixel electrodes arranged at intervals from each other and each including a pixel surface defining a pixel of the spatial light modulator;
a plurality of active layer regions extending across adjacent pixel electrodes at positions overlapping the pixel surfaces of the adjacent pixel electrodes and arranged at intervals from each other in a direction intersecting an arrangement direction of the plurality of pixel electrodes;
a plurality of driving switches respectively formed at the plurality of active layer regions and each including a scan terminal, a data terminal, and a control terminal;
a plurality of control lines each of which is connected between each control terminal and a corresponding one of the plurality of pixel electrodes;
a scan line arranged between the plurality of driving switches and the plurality of pixel electrodes and connected to the scan terminal of each of the plurality of active layer regions; and
a data line arranged between the plurality of driving switches and the plurality of pixel electrodes and connected to the data terminal of each of the plurality of driving switches,
wherein the scan line bypasses the plurality of control lines and extends between the plurality of driving switches and the plurality of pixel electrodes.

2. The pixel circuit substrate of claim 1, wherein the scan line includes a wiring segment extending across adjacent active layer regions.

3. The pixel circuit substrate of claim 1, wherein each of the plurality of control lines includes:
a control terminal line extending in a direction away from each control terminal;
an electrode line extending in a direction away from a corresponding one of the plurality of pixel electrodes; and
a relay line connecting the control terminal line and the electrode line and extending in the arrangement direction of the plurality of pixel electrodes,
wherein the scan line bypasses the control terminal line and extends between the plurality of driving switches and the relay line.

4. The pixel circuit substrate of claim 1, wherein the pixel surface has a rectangular shape.

5. The pixel circuit substrate of claim 4, wherein, in an extension direction of the plurality of active layer regions, a width of each of the active layer regions is longer than a width of the pixel surface.

6. The pixel circuit substrate of claim 4, wherein, in an arrangement direction of the plurality of active layer regions, a width of the active layer regions is shorter than a width of the pixel surface.

7. The pixel circuit substrate of claim 1, wherein the pixel surface has a square shape.

8. The pixel circuit substrate of claim 1, wherein the plurality of active layer regions is formed of a single crystal material selected from a group consisting of Si, SiC, GaN and Ga2O3.

9. A spatial light modulator, comprising:
the pixel circuit substrate of claim 1;
a transparent electrode forming a driving circuit together with a pixel circuit of the pixel circuit substrate; and
a light modulation layer disposed between the plurality of pixel electrodes and the transparent electrode and to which voltage is applied from the driving circuit.

10. The spatial light modulator of claim 9, wherein the light modulation layer is formed of a ferroelectric liquid crystal.

11. A display system comprising the spatial light modulator of claim 9.

12. The display system of claim 11, wherein the display system is a holographic display for hologram reproduction.
